(19) United States
(12) Patent Application Publication
(10) Pub. No.: US 2002/0147596 A1
(43) Pub. Date: Oct. 10, 2002

(54) On-line laboratory services brokerage system

(76) Inventors: Steve A. Vanderboom, Medina, MN (US); David L. Stalling, Lenexa, KS (US)

Correspondence Address: Walter C. Linder, FAEGRE & BENSON LLP, 2200 Wells Fargo Center, 90 South Seventh Street, Minneapolis, MN, 55402-3901, US

(21) Appl. No.: 09/759,651

(22) Filed: Jan. 12, 2001

Related U.S. Application Data
(60) Provisional application No. 60/176,149, filed on Jan. 14, 2000.

(51) Int. Cl. G06F 17/60

(52) U.S. Cl. 705/1

(57) ABSTRACT

An on-line, web-based laboratory services brokerage system. The system website operator enlists and maintains a network of member laboratories having underutilized scientific laboratory capabilities. An electronic database of the member laboratory capabilities is also maintained by the operator. Customer requests for proposals (RFPs) for laboratory service projects are received over the internet. In response to the RFPs, a scientist at the system business will review and select from the database one or more member laboratories which may be capable of performing the requested laboratory service projects. The system business will then provide the selected laboratories, over the internet, descriptions of the requested laboratory service projects, and present the selected laboratories the opportunity to make proposals of the terms on which the laboratories desire to pursue the requested projects. Proposals from the selected laboratories with the terms on which the laboratories desire to pursue the requested laboratory service projects are returned to the system business over the internet. The proposals received from the selected member laboratories are then sent to the customer over the internet, and the customer given the opportunity to make decisions on the proposals.

### REFERENCE TO RELATED APPLICATION

This application claims the benefit of U.S. Provisional Application Serial No. 60/176,149, filed on Jan. 14, 2000 and entitled Internet-Based Laboratory Services Brokerage System, which is hereby incorporated by reference in its entirety.

### FIELD OF THE INVENTION

The present invention is a method for operating an on-line scientific laboratory services brokerage business.

### BACKGROUND OF THE INVENTION

The market for scientific measurement, research and problem solving, and routine testing services (i.e., laboratory services) is large and growing. Laboratory services include all types of environmental, pharmaceutical, agricultural, physical and chemical testing performed by laboratories such as those affiliated with corporations, universities and government organizations. Within this market the outsourcing of laboratory services is gaining in popularity. The trend in the laboratory services industry is towards knowledge management rather than the production of analytical results in internal laboratories. The market for laboratory services is also highly fragmented. This fragmentation, cyclical demand, and the unpredictable nature of the workflow at each laboratory, create high levels of excess capacity in a large number of laboratories.

The market conditions in the laboratory services industry create inefficiencies for both customers and laboratories. Because there is no single source for access to laboratories, customers must spend a great deal of time locating a laboratory best suited to their needs. This process often requires customers to use direct contact, word of mouth and various on-line and traditional research techniques to describe the project requirements and to locate the appropriate laboratory. Purchases of laboratory services are commonly made using a paper-based ordering system that delays the time in which customers can generate purchase orders, contact laboratories and receive information on their tests.

There remains, therefore, a continuing need for a system that can efficiently and rapidly link customers and laboratories. A solution will preferably offer a single-source marketplace with comprehensive service offerings, efficient order and tracking capabilities and analytical problem solving abilities.

### BRIEF DESCRIPTION OF THE DRAWINGS

FIG. 1 is a graphic illustration of the on-line laboratory services brokerage system of the present invention.

FIG. 2 is an illustration of a map describing a website for implementing the on-line laboratory services brokerage system of the invention.

FIGS. 3₁-3₁₉ are illustrations of pages of a website in accordance with one embodiment of the present invention.

FIG. 4 is a flowchart describing an example of the method by which laboratory services can be contracted for and delivered using the on-line method of the present invention.

FIG. 5 is a flowchart describing an example of the method by which requests for proposals for laboratory services projects can be created and submitted using the on-line method of the present invention, including the system generation of laboratory choices based on the contents of the RFP.

FIG. 6₁-6₃ are illustrations of the format by which descriptions of requested laboratory service projects can be presented to member laboratories, and buttons by which the member laboratories can respond to the descriptions.

FIG. 7 is an illustration of an example of the front page of an inventory tool that enables entry into the website database of laboratory capabilities such as instrumentation and methods.

FIGS. 8₁-8₁₀ list and organize example categories of the member laboratory capabilities which can be used to match complex problem solving requirements with laboratories in the website database.

FIGS. 9₁-9₄ list and organize example member laboratory scientist inventory, general information, and capabilities summary which can be used to match complex problem solving requirements with laboratories in the website database.

FIG. 10 is a chart describing examples of membership options for member laboratories in the on-line laboratory services brokerage system of the invention.

FIG. 11 is a graphic illustration of reports generated during operation of the brokerage system of the present invention.

FIG. 12 is a graphic illustration of a database of laboratories' capabilities and a website for an enterprise version of an on-line laboratory services brokerage system in accordance with a second embodiment of the present invention.

FIG. 13 is a graphic example and flowchart of a cascading wizard which enables a user to identify and select a laboratory capability in the database in connection with the invention.

FIG. 14 is a graphic example and flowchart of a linear wizard which enables the use of more than one cascading wizard in order to identify and select more than one laboratory capability in connection with the invention.

### DETAILED DESCRIPTION OF THE PREFERRED EMBODIMENTS

### Overview

The present invention is an on-line laboratory services brokerage system which functions as a marketplace for laboratory services. The system makes use of the internet (i.e., an electronic network) to connect all types of customers for these services with a group or network of member laboratories. The brokerage system leverages the internet to provide an efficient single source for laboratory services that is easily scalable, both as to the services provided and the size of network of member laboratories. The system allows customers to conveniently and rapidly locate cost-effective laboratories for completing published method tests as well as laboratories with capabilities which qualify them to analyze and solve complex problems. The system also provides the member laboratories with a low risk mechanism for leveraging their fixed costs and generating revenue from excess capacity. The website-based format provides customers equal and rapid access to a comprehensive range of laboratories, including Fortune 500 corporate laboratories, and a standardized purchasing environment. The business or other organization that provides the brokerage system (sometimes referred to as the organizations “LabSeek” and/or “Global Laboratory Resources” (GLR) in the drawing figures, and hereinafter referred to in this detailed description section as the “system business”) will help ensure that customers receive all support services necessary to connect with the appropriate laboratory. Customers can service most if not all of their needs at one secure location regardless of whether they are engaging in price comparison for published methods tests or seeking the best laboratory to address a unique and complex problem. The system will provide a database of all testing orders and results for all customers to give them increasing efficiencies on repeat purchases. Customers are also allowed to select one of several desired levels of confidentiality.

The on-line marketplace enabled by the system offers the member laboratories a cost-effective mechanism to access customers for laboratory services. The result can be a new revenue stream for an organization's internal laboratory or laboratories and can be achieved with little or no additional investment in sales and marketing infrastructure. The laboratories have minimal administrative costs as a result of customer orders since the brokerage system business handles all invoicing and corrections, as well as numerous other services. By participating in an on-line marketplace that allows for rapid distribution of customer orders to a broad network, the member laboratories are able to utilize excess instrument, facility and scientist capacity whenever available. This allows the member laboratories to leverage their fixed costs without making a large, inflexible commitment of capacity. The member laboratories are also able to access the services of other member laboratories at preferred prices and will be able to barter their scientific expertise for the expertise of other laboratories.

### General System Description

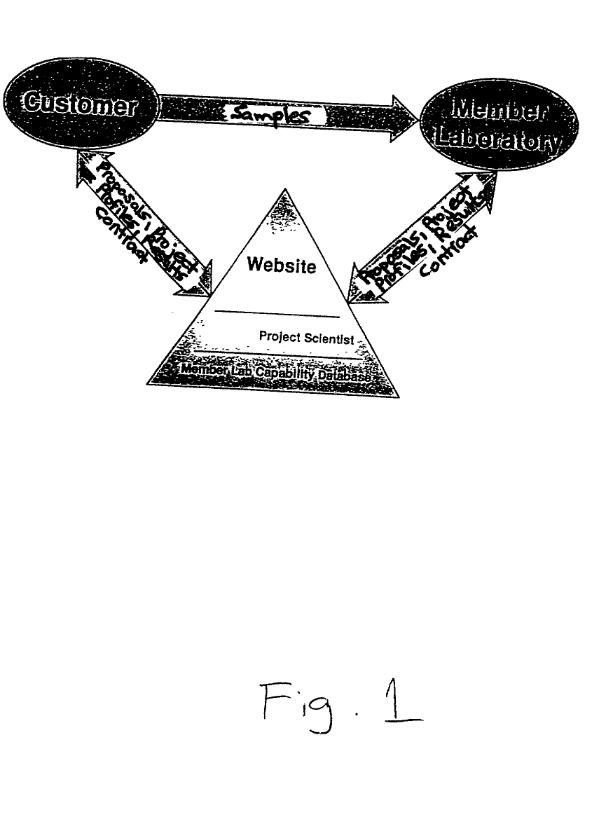

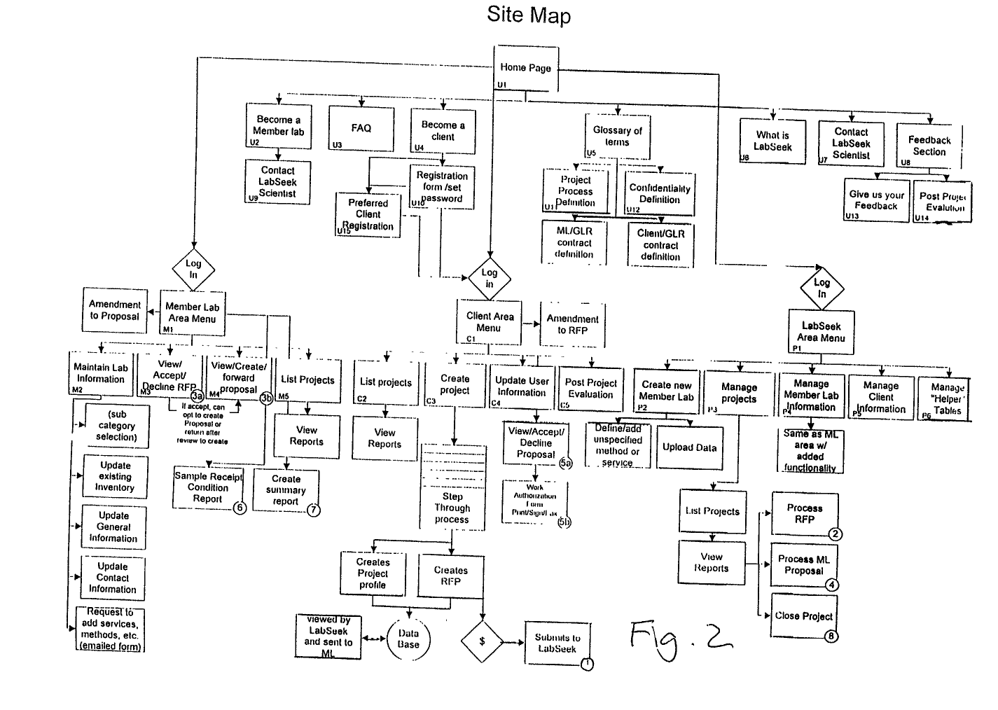

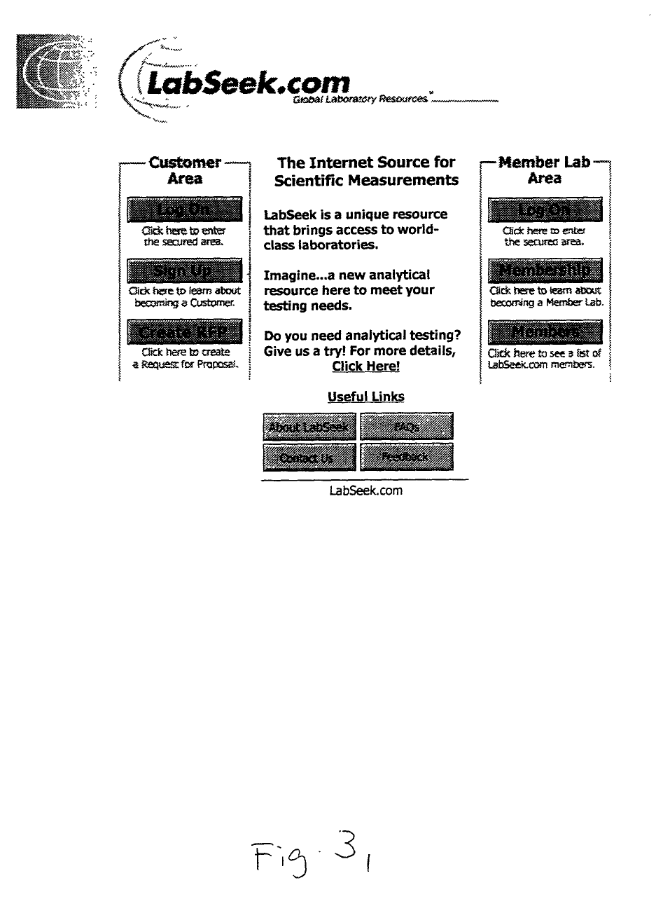

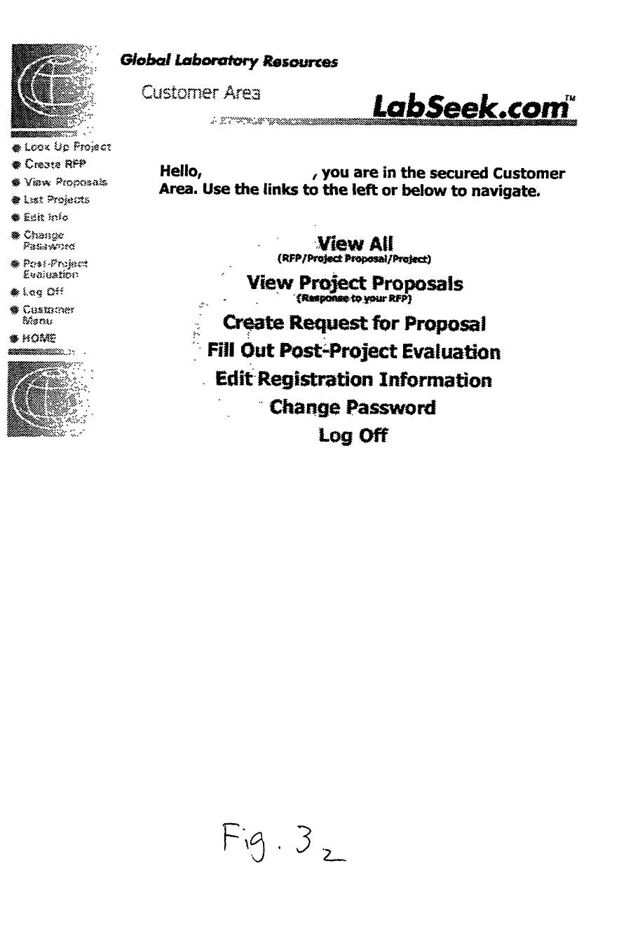

FIG. 1 is a graphic illustration of the on-line laboratory services brokerage system of the present invention. In the embodiment shown, the brokerage system is implemented through an internet website maintained by the system business. The database and website serve as the backbone of the laboratory brokerage system. The web server will typically include random access memory (RAM) and hard disk storage. Back-up capabilities can be provided. System software can be based on the Windows NT or another operating system. One embodiment of the invention uses a Microsoft-based system designed to facilitate migration to support efficient growth. Important business functions are accommodated by the internet platform. These functions include:

Establishing and updating the laboratories' profiles and capabilities in the system database.

Establishing customer information, including automatic credit checks, technical contacts and billing information.

Project description formats to summarize new projects.

Search facilities to match customer requests with qualified laboratories.

Request for proposal (RFP) formats for projects requiring standard methods.

Proposal formats outlining project scopes and pricing.

Daily reports summarizing active projects.

Invoices automatically generated at the completion of projects.

Accounts receivable status reports.

E-mail utility for internal and external communication.

Contact management system for sales personnel.

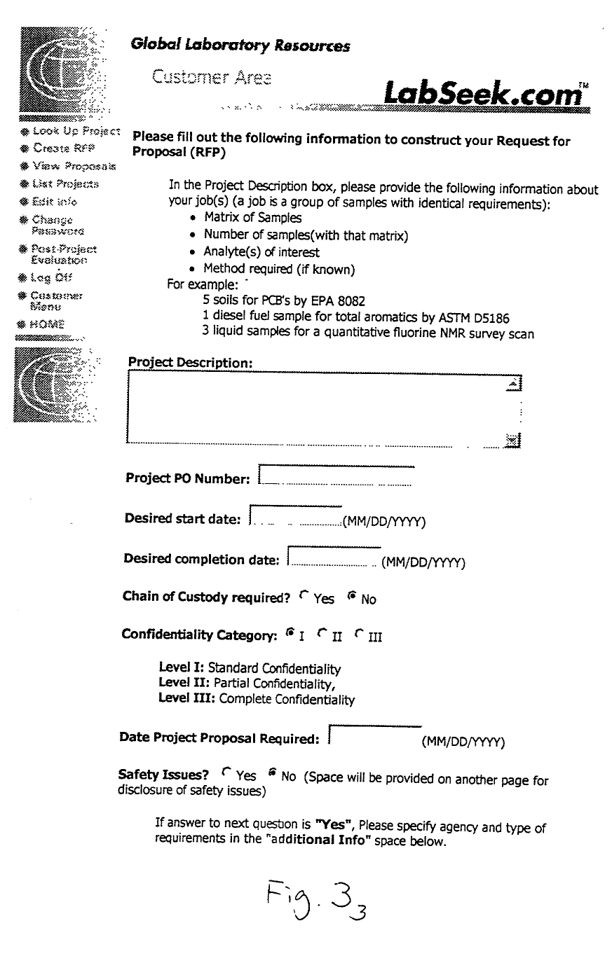

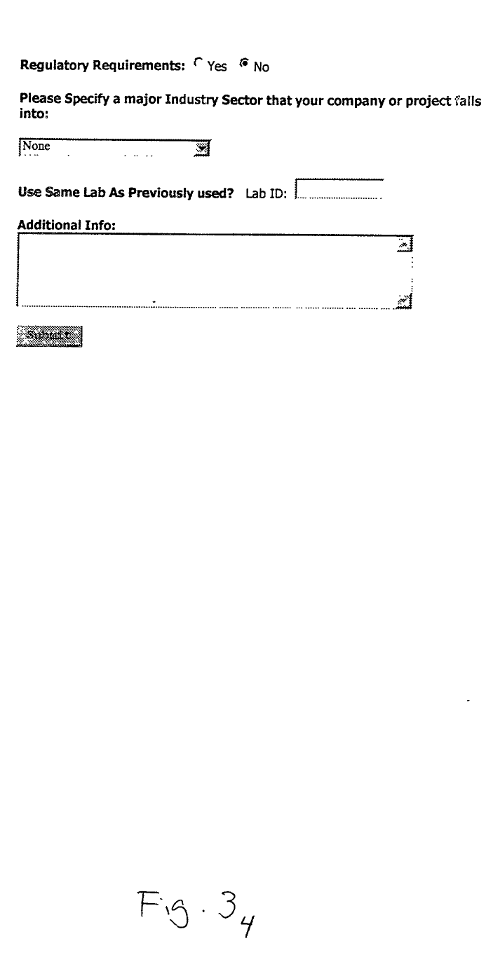

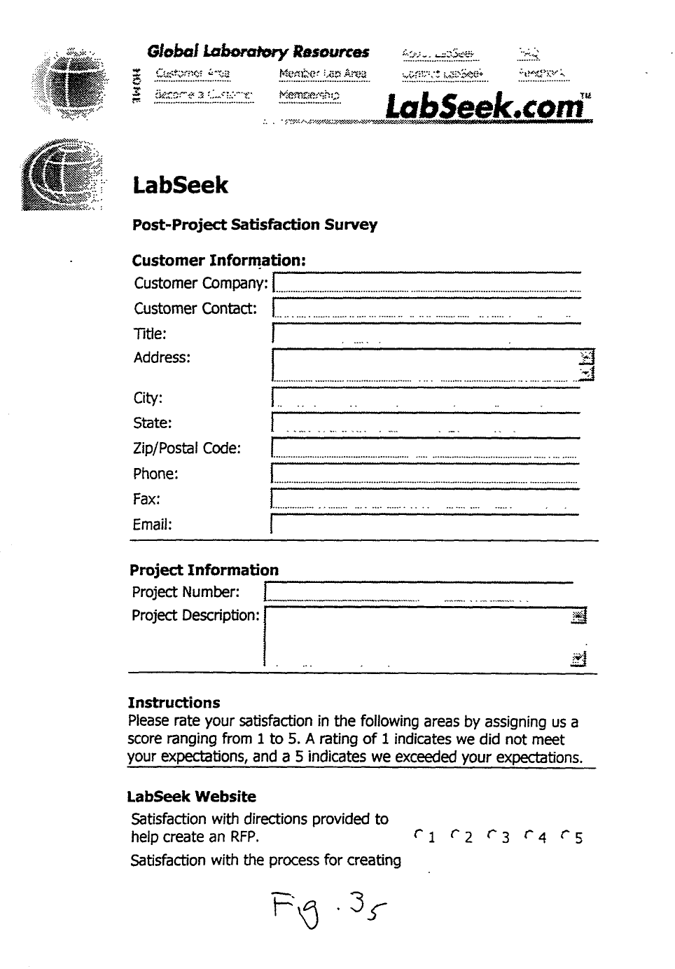

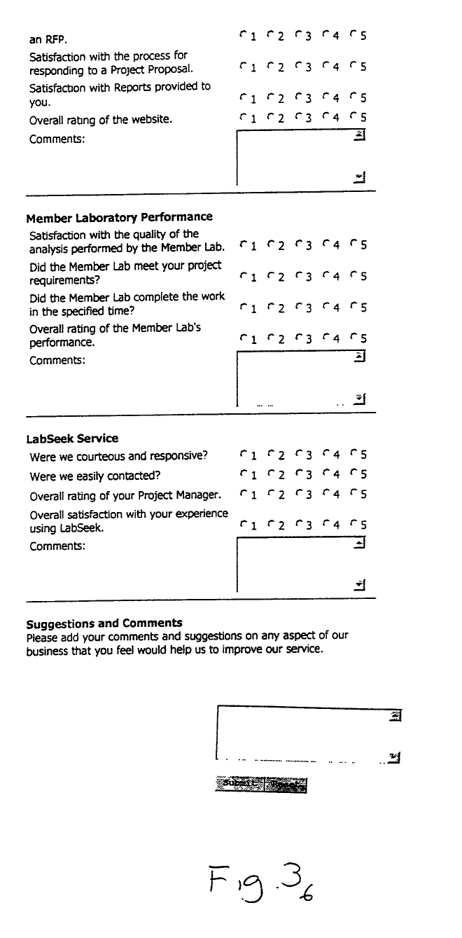

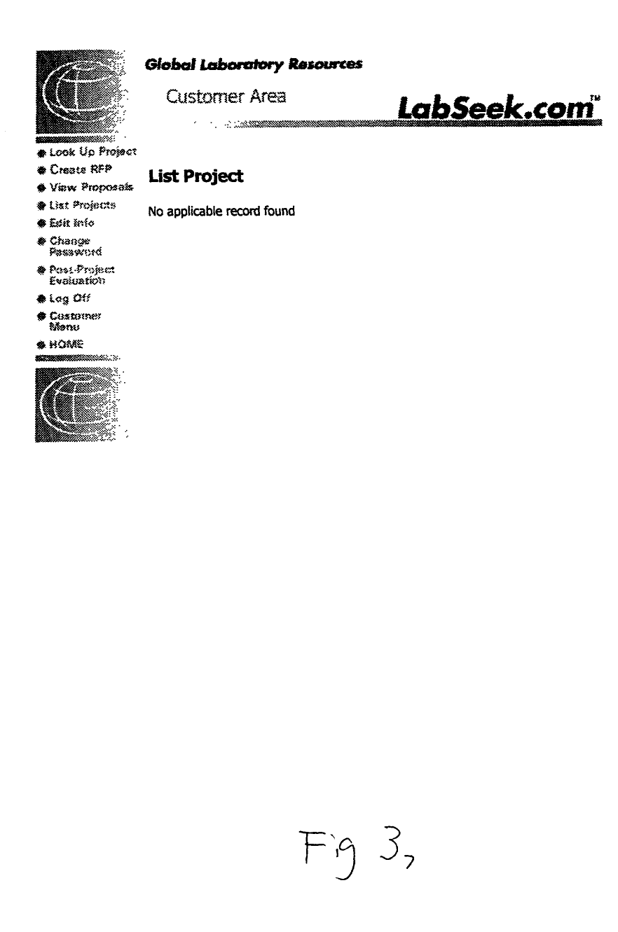

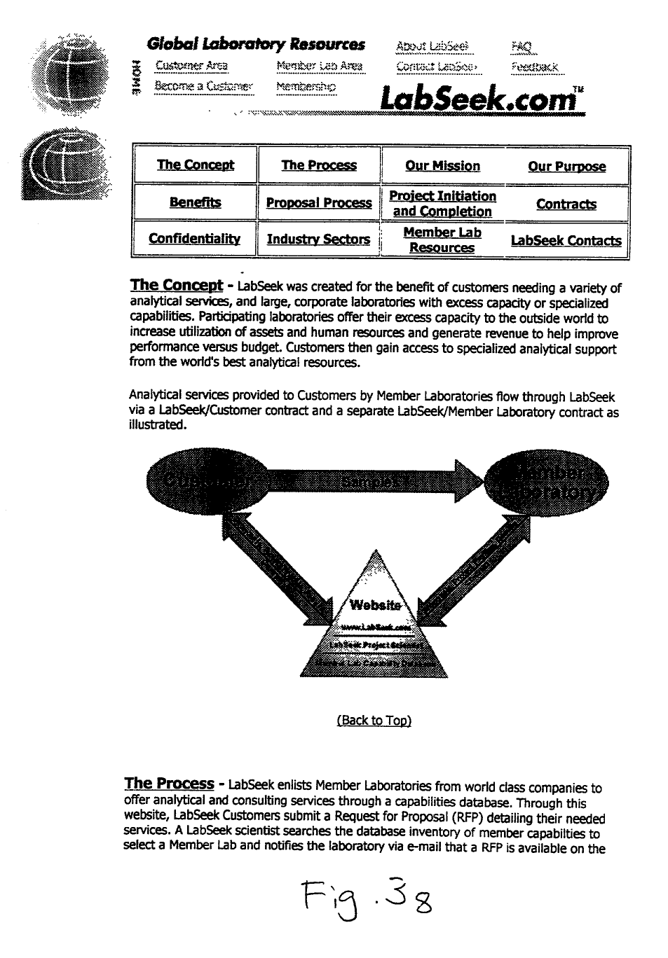

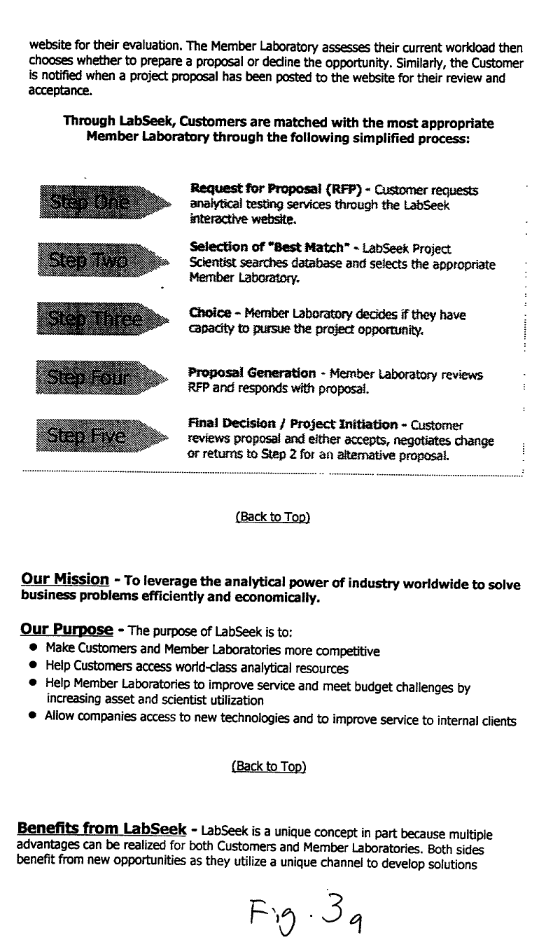

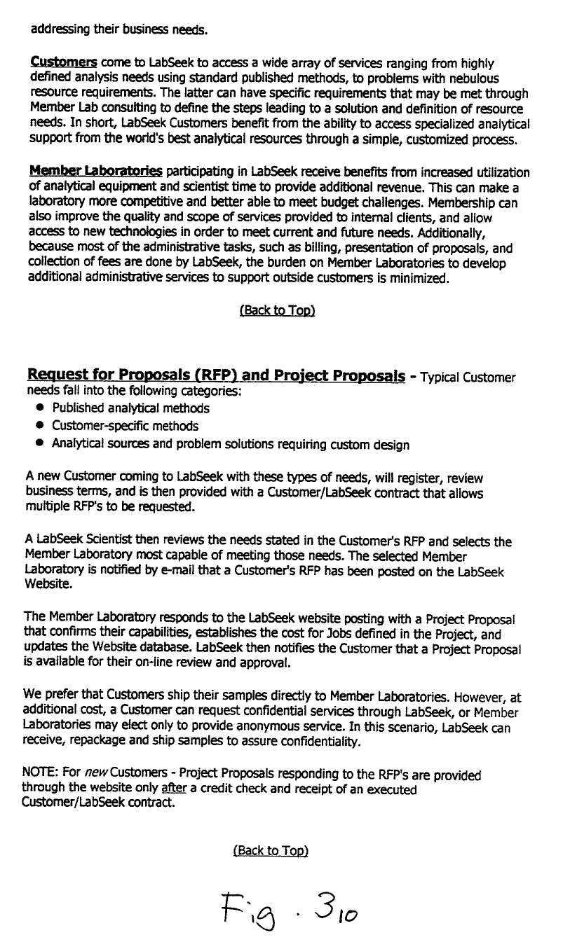

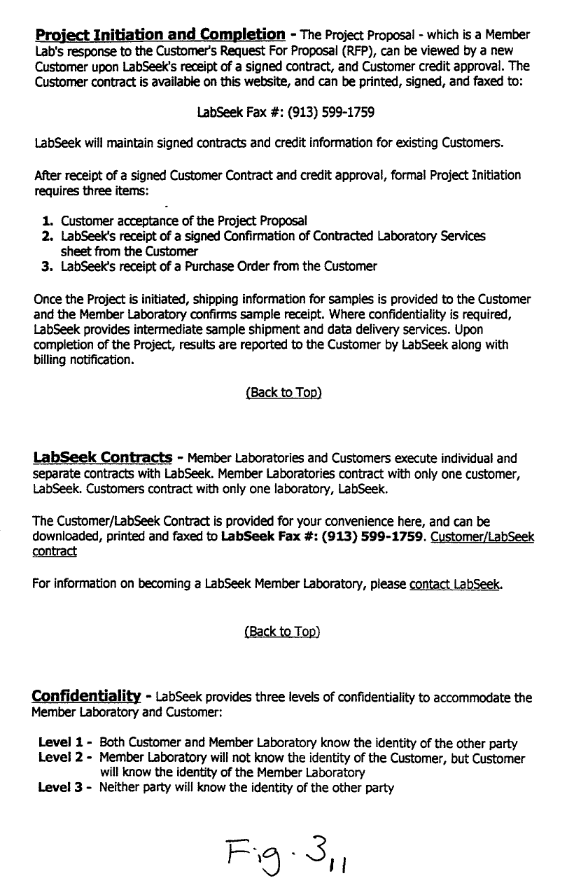

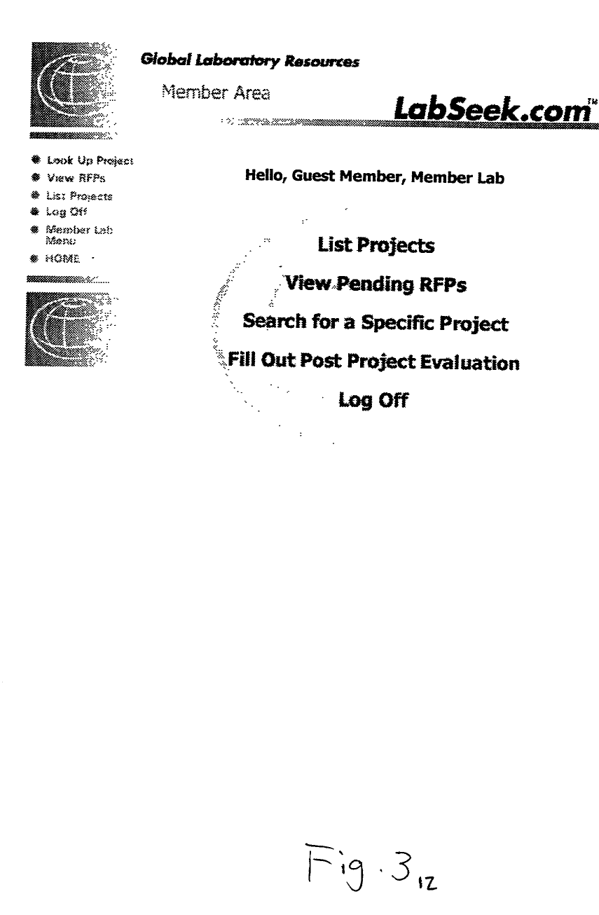

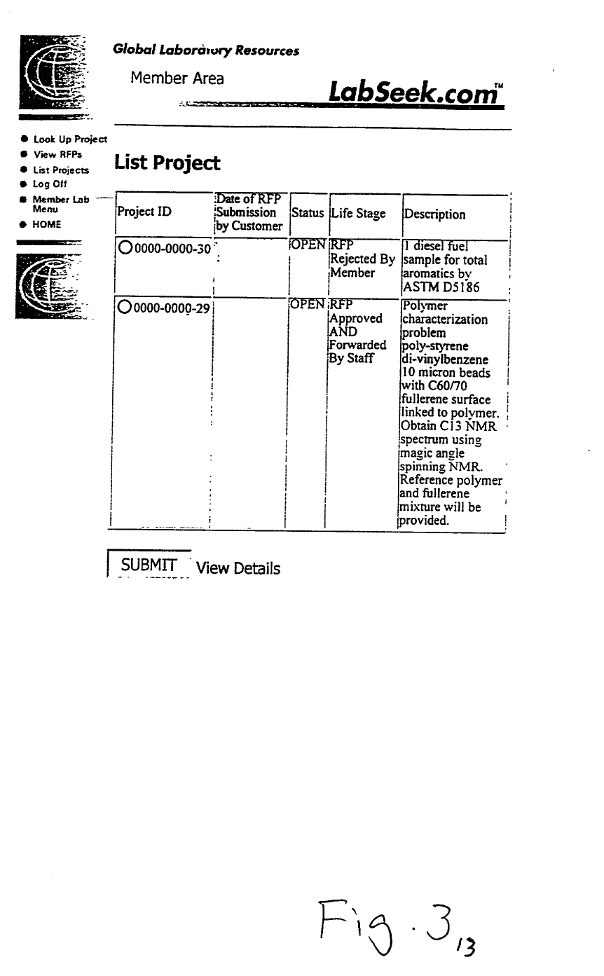

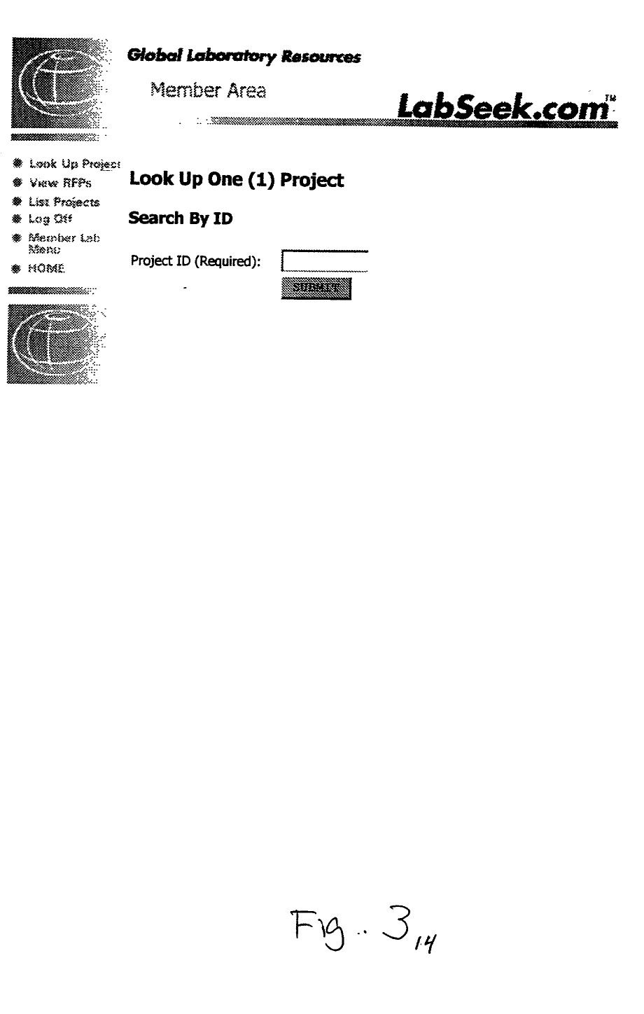

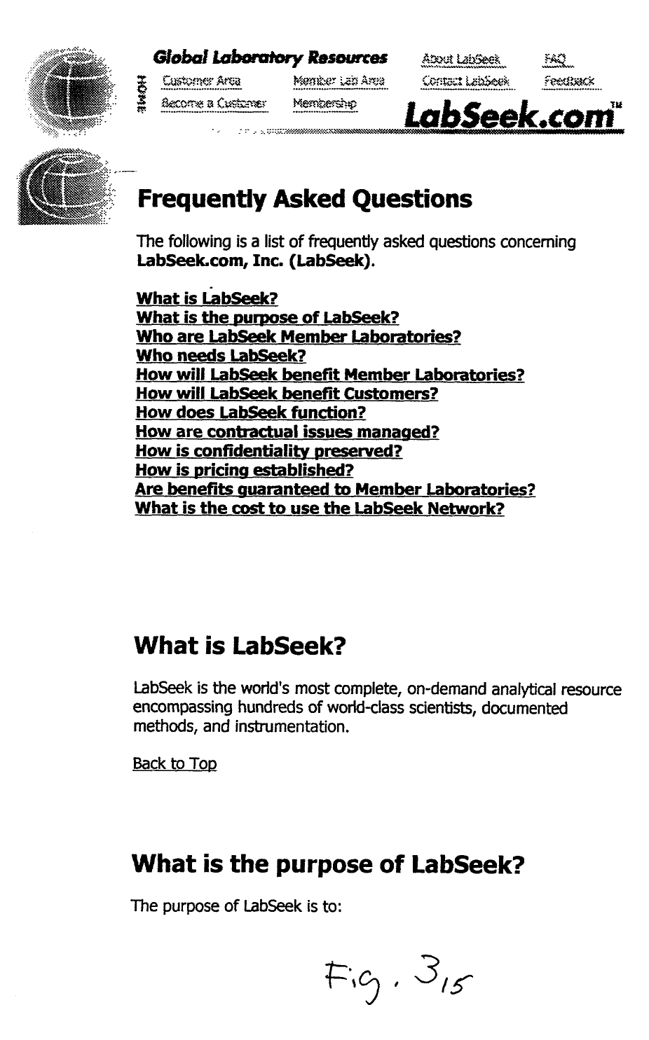

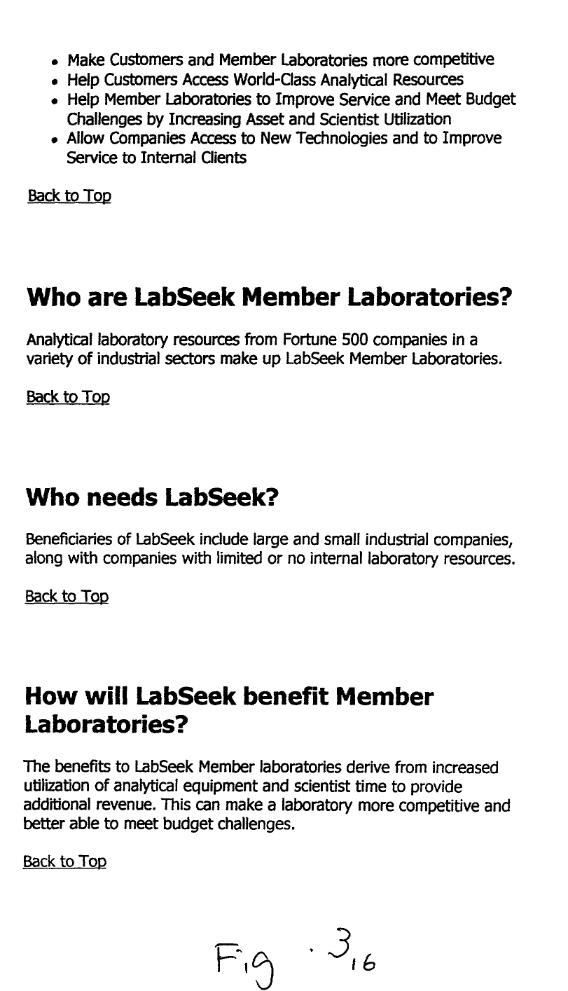

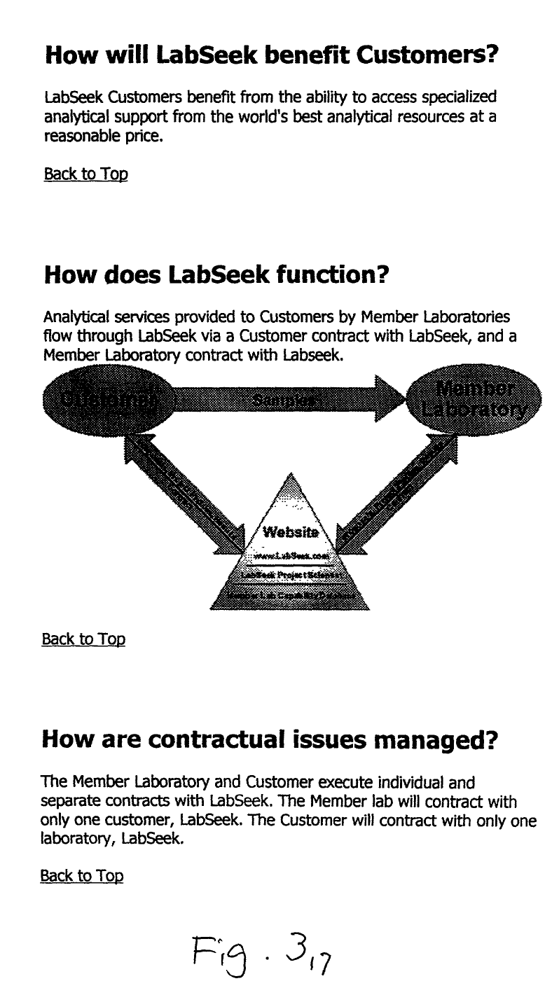

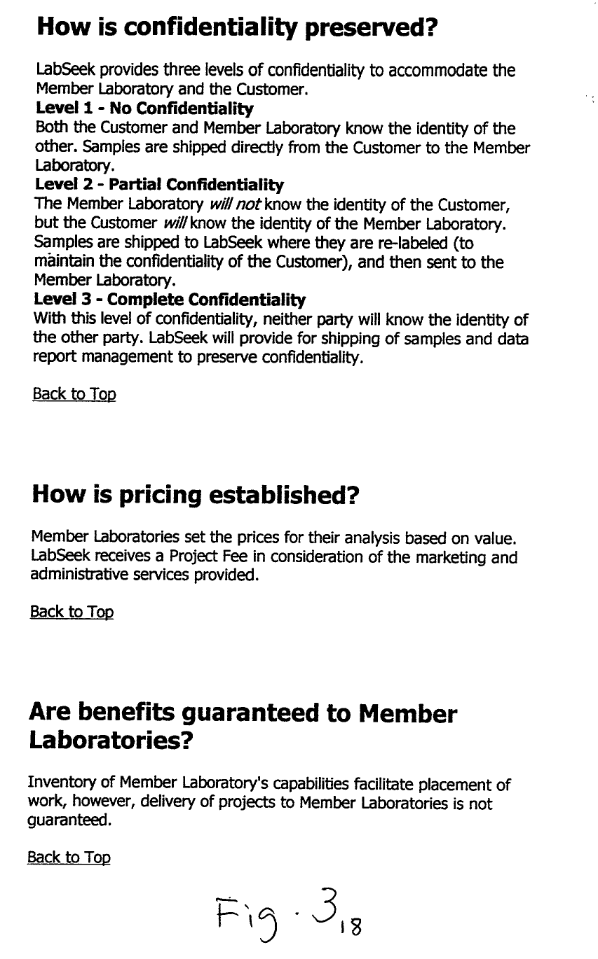

A detailed map of the website pages and their sequence of interaction, as well as a description of the information and/or function of the pages, is shown in FIG. 2. FIGS. 3₁-3₂₀ are illustrations of pages of a website in accordance with one embodiment of the present invention.

The ultimate billing of the customer, the presentation of the proposal, contract management and collection of transaction fees are a part of the service provided to member laboratories by the brokerage system business. These provisions will minimize the burden to the member laboratories to develop administrative services for support of outside customers.

### General System Methodology

The process used to link customers with one or more member laboratories includes a number of steps. FIG. 4 is a flowchart describing an example of the method by which laboratory services can be contracted for and delivered using the on-line method of the present invention. FIG. 5 is a flowchart describing an example of the method by which requests for proposals for laboratory services projects can be created and submitted using the on-line method of the present invention, including the system generation of laboratory choices based on the contents of the RFP.

Member laboratories participating in the system must be enlisted and maintained. Generally, the member laboratories will have underutilized scientific laboratory capabilities. An electronic database of the member laboratory capabilities (including their instrumentation, published methods, laboratory methods, techniques, specializations and scientist expertise) is also maintained.

When a customer desires to contract for a laboratory services project, he or she will prepare a request for a proposal (RFP). The customer can, if they wish, specify a laboratory having certain characteristics (e.g., in a specific industry). These customer requests for analytical testing services are made through the interactive website. The RFP will be transmitted over the network, and received electronically by the system business.

Upon the receipt of an RFP, one or more member laboratories which may be capable of performing the requested services project is selected from the database. This step can involve the selection of a “best match” laboratory. As described in greater detail below, individuals such as project scientists working on behalf of the system business can search the database and select the appropriate member laboratory on the basis of its capabilities. Alternatively, one or more appropriate member laboratories can be selected automatically, without human intervention. In situations where multiple member laboratories in each category match the requirements for an RFP, the RFP can be presented sequentially to member laboratories based on a number of factors such as 1) qualifications, 2) task performance, 3) work distribution, and 4) tenure with the brokerage system business. If all member laboratories within a category decline an RFP opportunity, the next designated member laboratory category can be searched using the same criteria.

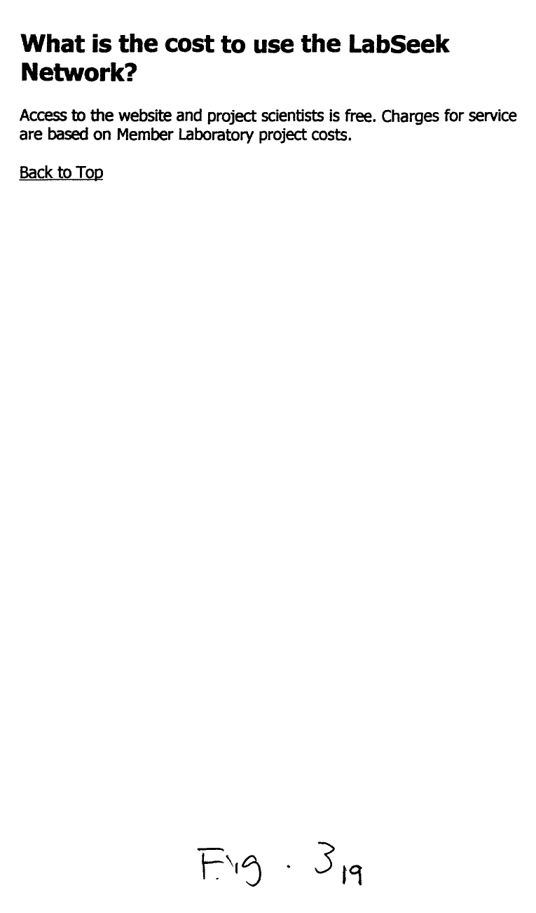

The next step involves the member laboratory's choice. Descriptions of the requested laboratory services projects are presented to each selected member laboratory in electronic format over the network. The member laboratory can be notified by e-mail that an RFP is available at their website for their evaluation. Each selected member laboratory reviews the RFP and decides if it has the capacity and interest to pursue the project opportunity. Alternatively, the member laboratory can suggest a modification to the proposal. In effect, the member laboratories are presented the opportunity to make proposals of the terms on which the laboratories desire to pursue the requested laboratory services projects. FIG. 6₁-6₃ are illustrations of the format by which descriptions of requested laboratory service projects can be presented to member laboratories, and buttons by which the member laboratories can respond to the descriptions.

A member laboratory which decides to pursue a project responds with a proposal. The proposals are received by the system business electronically, over the network.

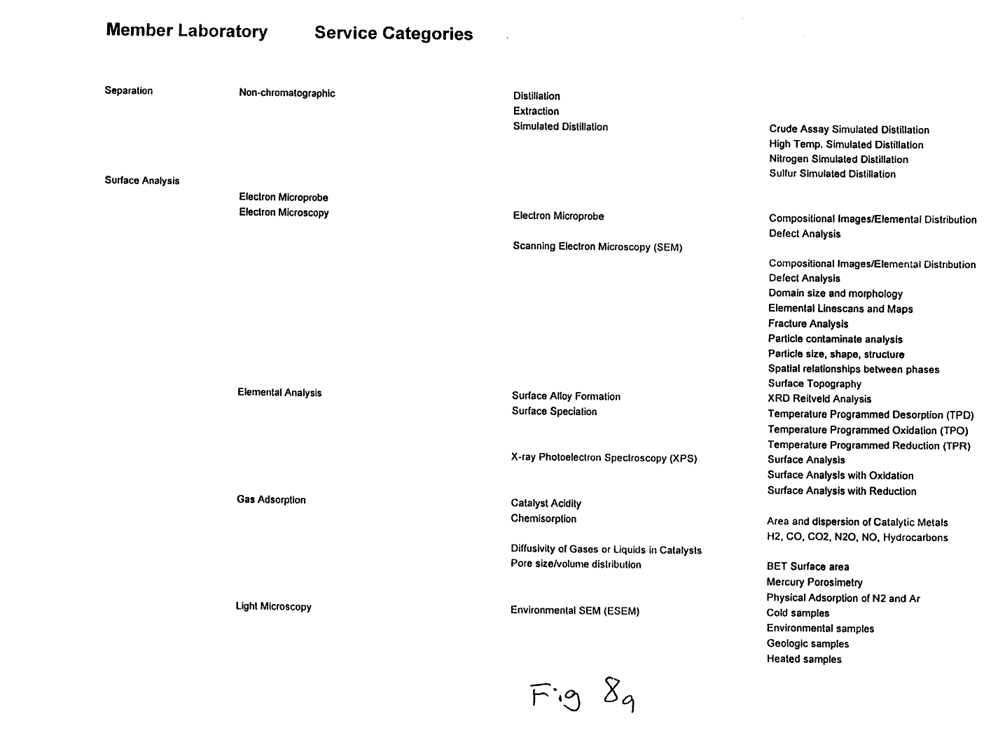

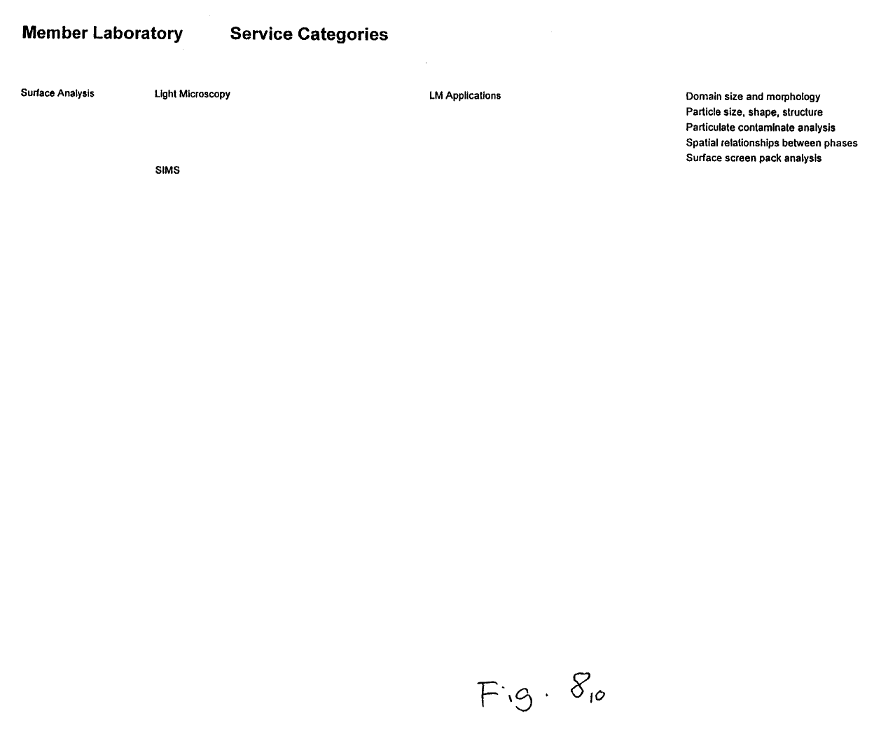

The proposals received from the member laboratories are then provided electronically, over the network, to the customer that submitted the associated RFP. This function can be provided by notifying the customer when the project proposal has been posted to the website for their review and acceptance. The customer can then review the proposal. Following the review, the customer will typically either accept, negotiate changes or decline the proposal. Alternatively, the customer can repeat the process described above by submitting another RFP for an alternative proposal. If a proposal is accepted, sample transfer information is confirmed between the customer and the member laboratory. FIG. 11 is a graphic illustration of reports generated during operation of the brokerage system of the present invention.

### Member Laboratories and Database

The brokerage system provider will enlist corporate research laboratories, commercial labs, non-profit research institutes and/or university or institutional laboratories with specialized capabilities. Industrial categories can include the following:

| Tier 1 | Tier 2 | Tier 3 |
|---|---|---|
| Chemical | Medical Products | Agriculture |
| Medical Products | Scientific Products | Nutrition Labeling |
| Petroleum | Forest and Paper | Rubber and Plastics |
| Electronics | Medical | Clinical Research |
| Food | Clinical Research | Conformance Testing |
| Pharmaceutical | | |
| AgChem/Biotech | | |

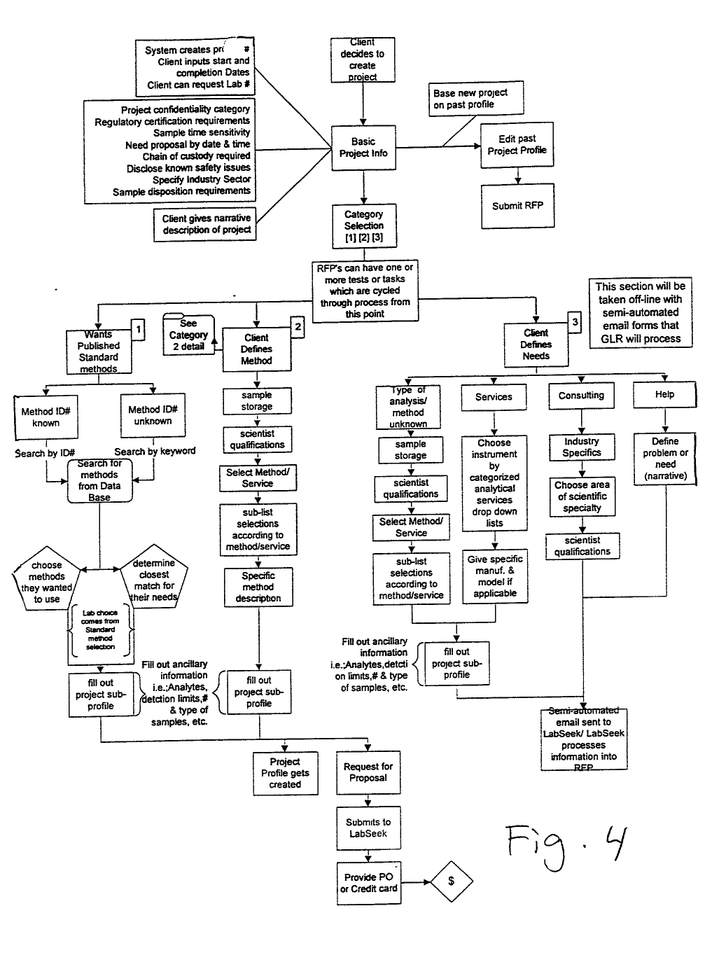

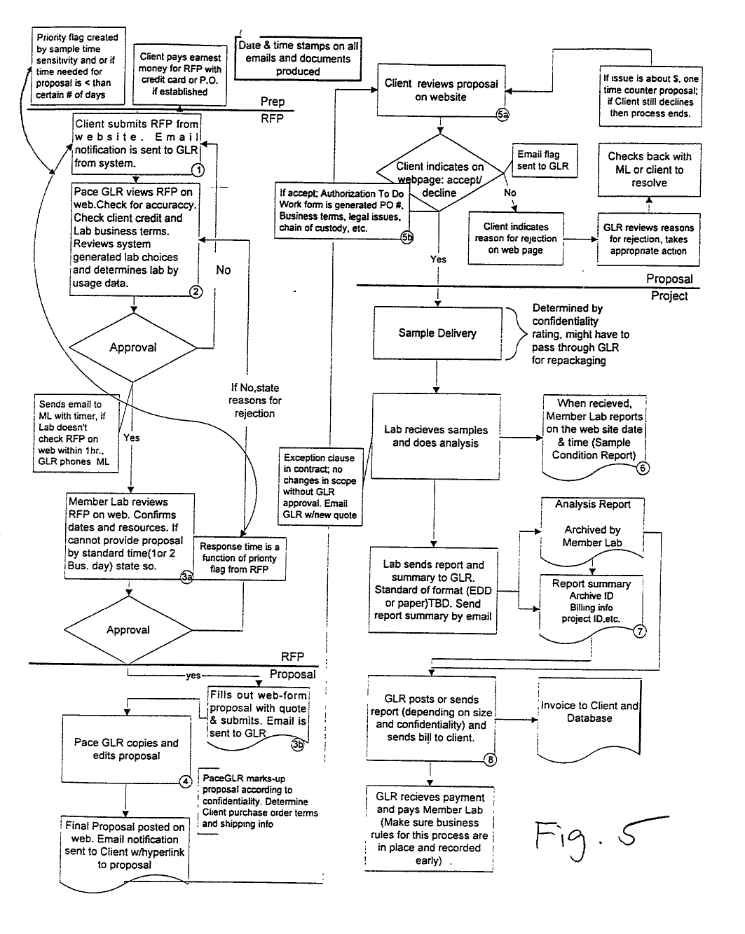

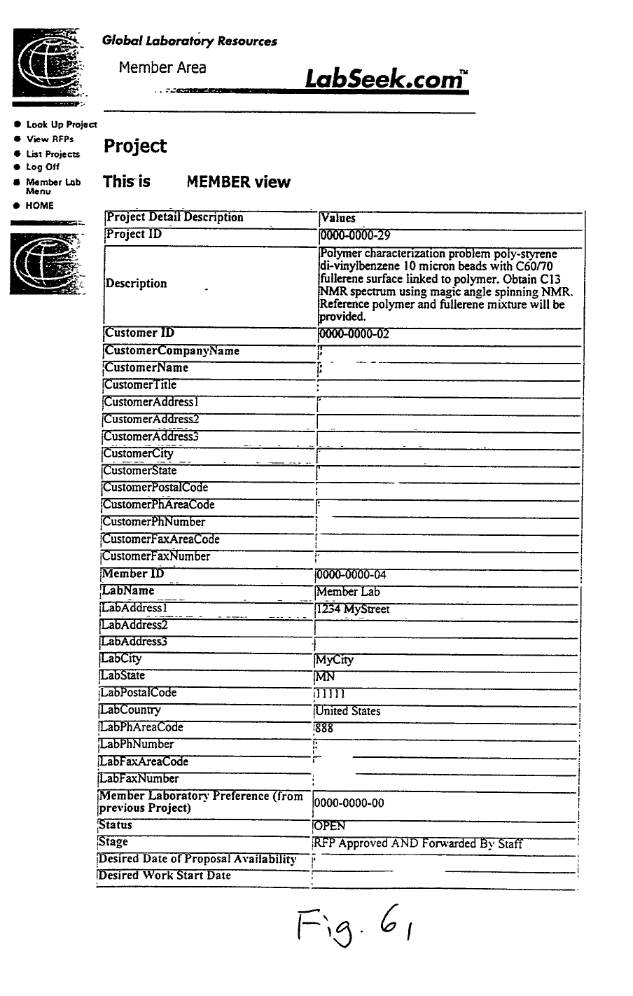

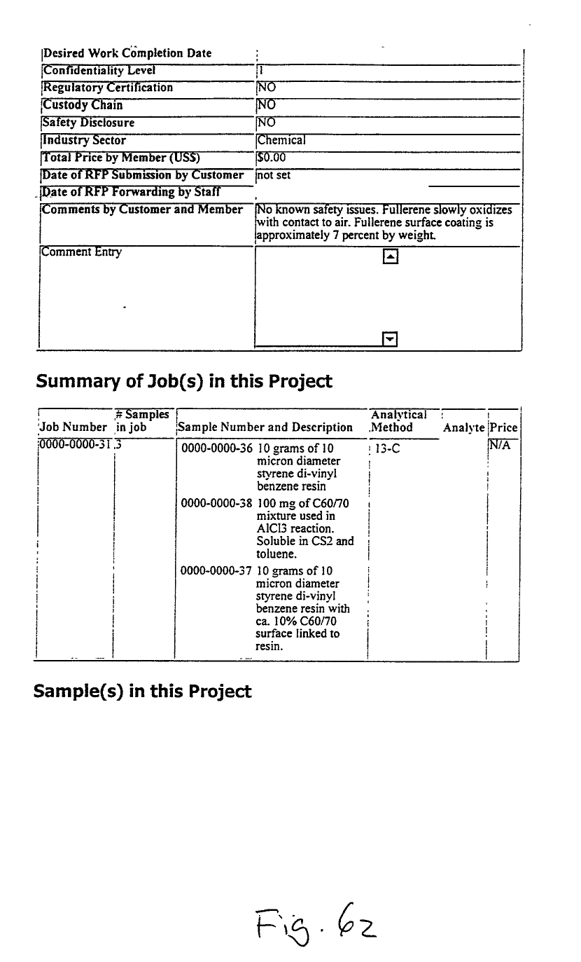

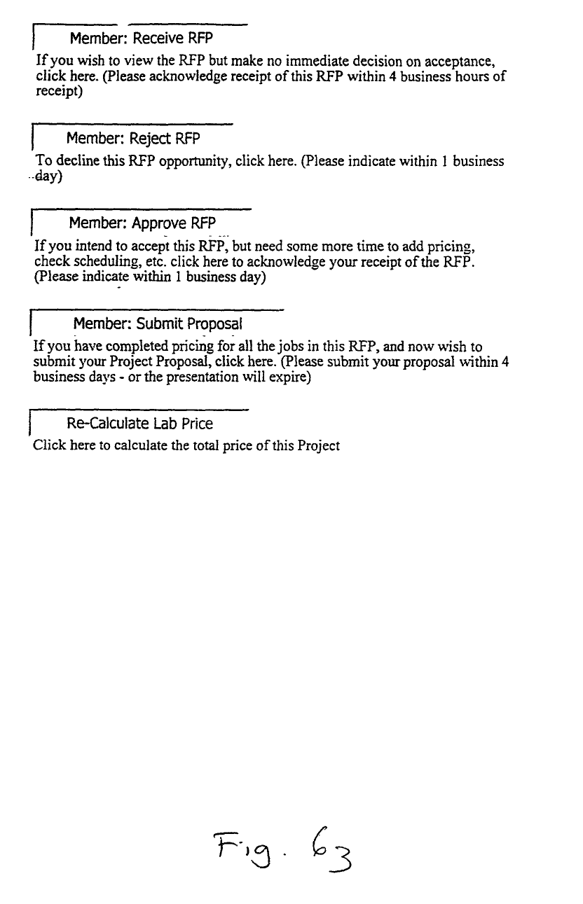

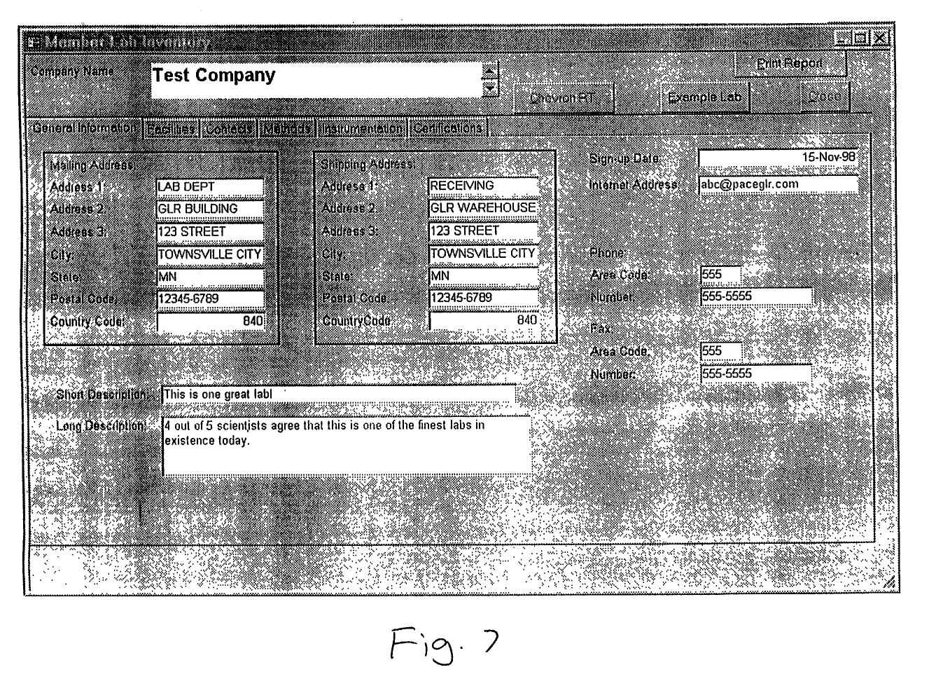

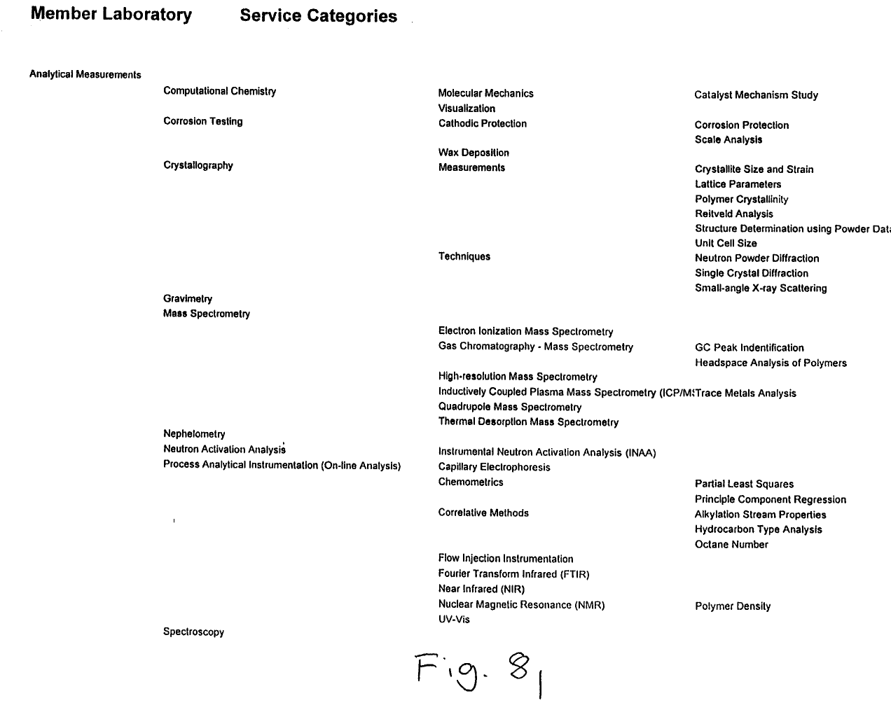

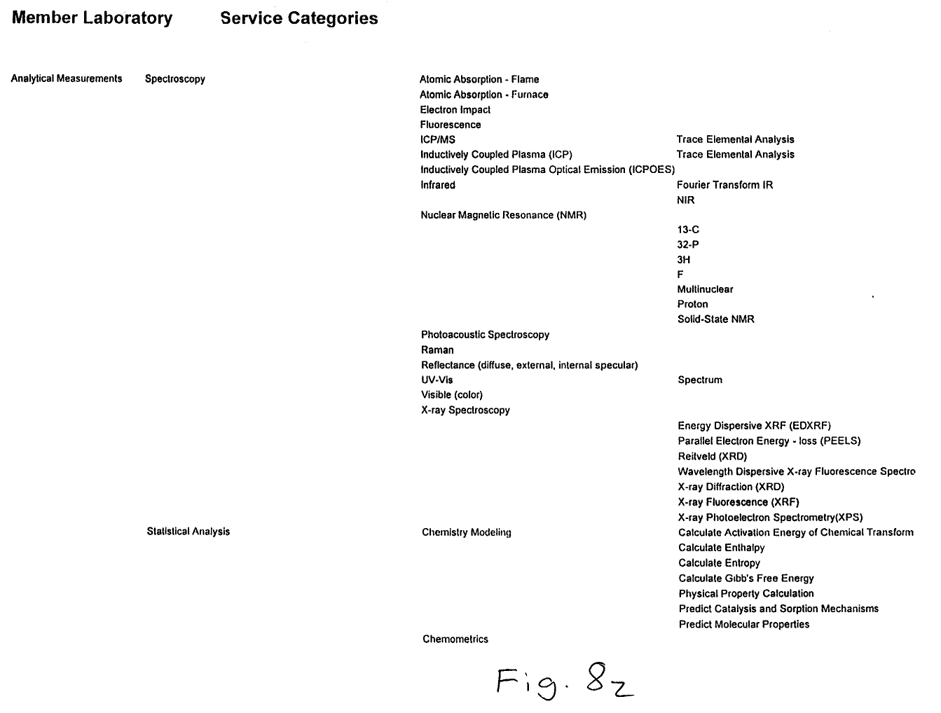

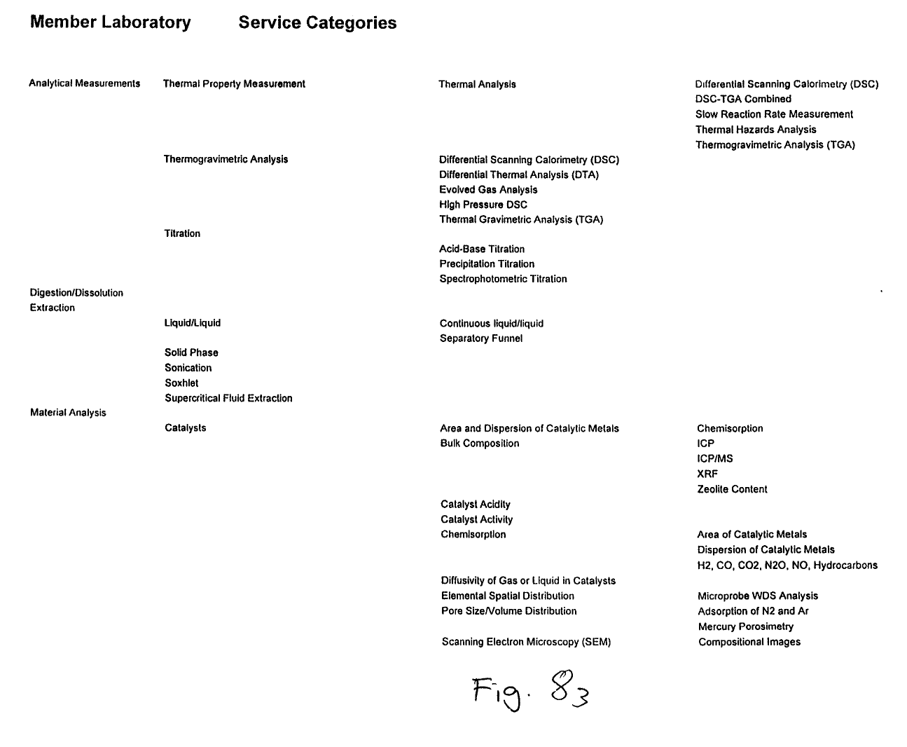

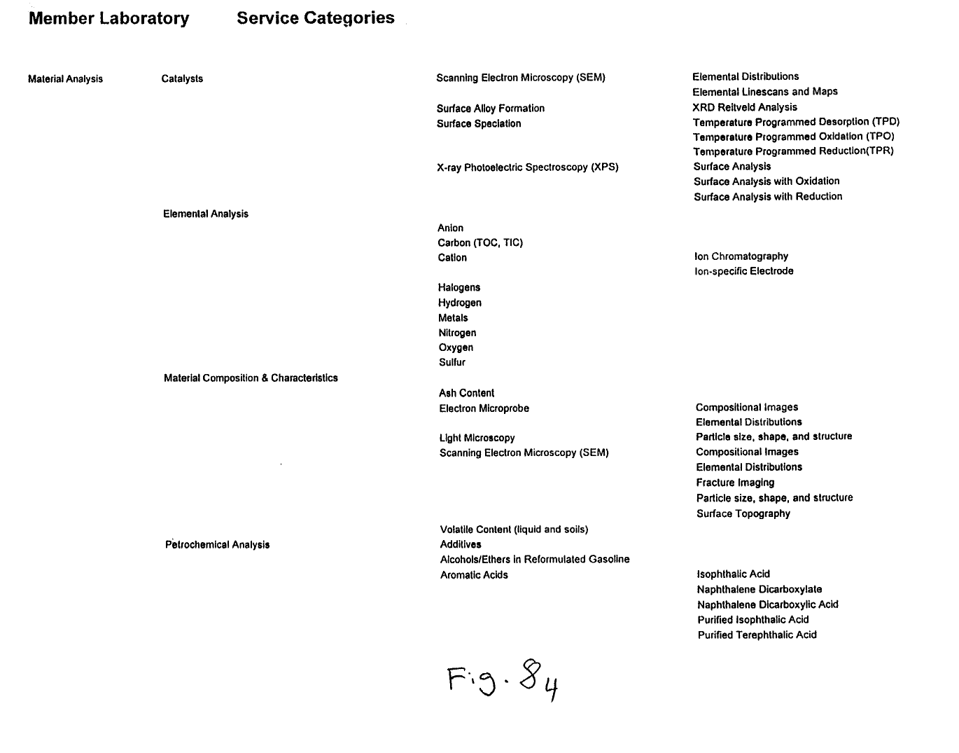

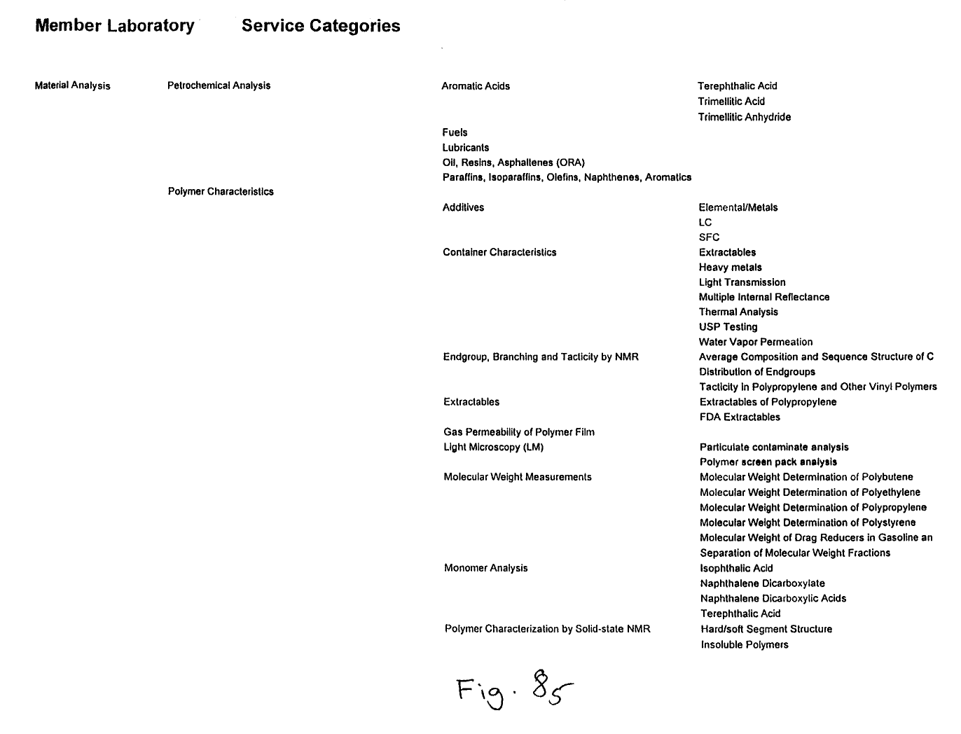

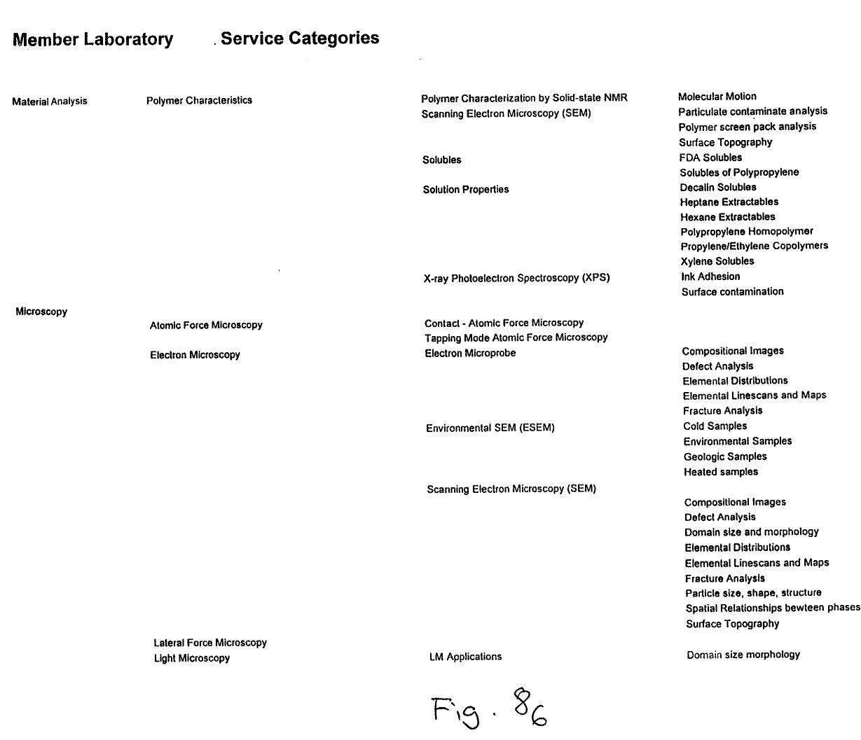

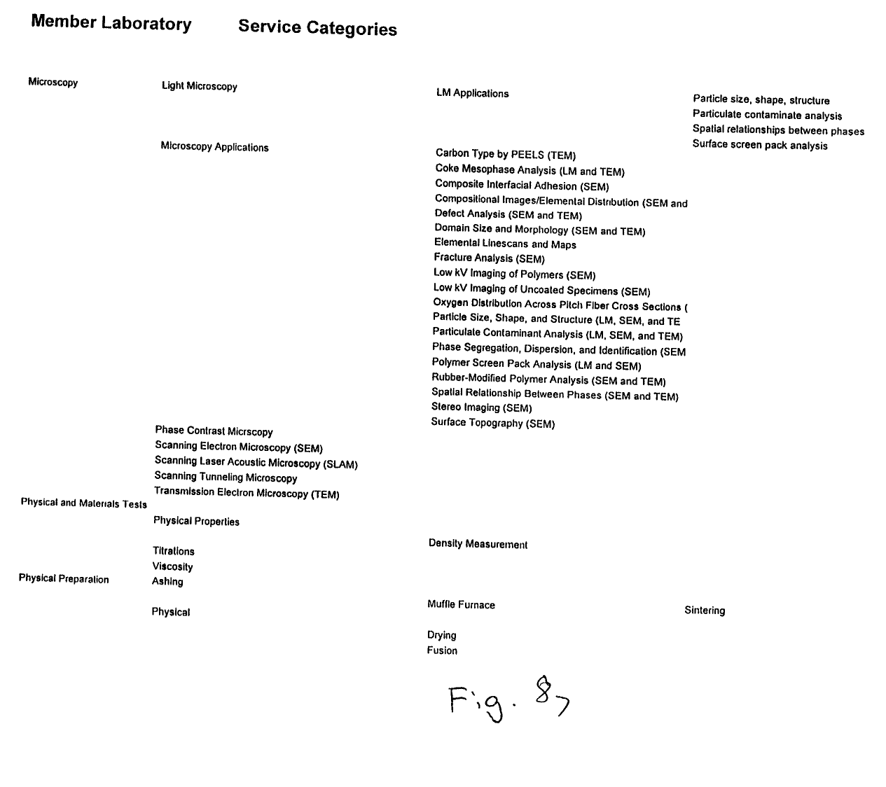

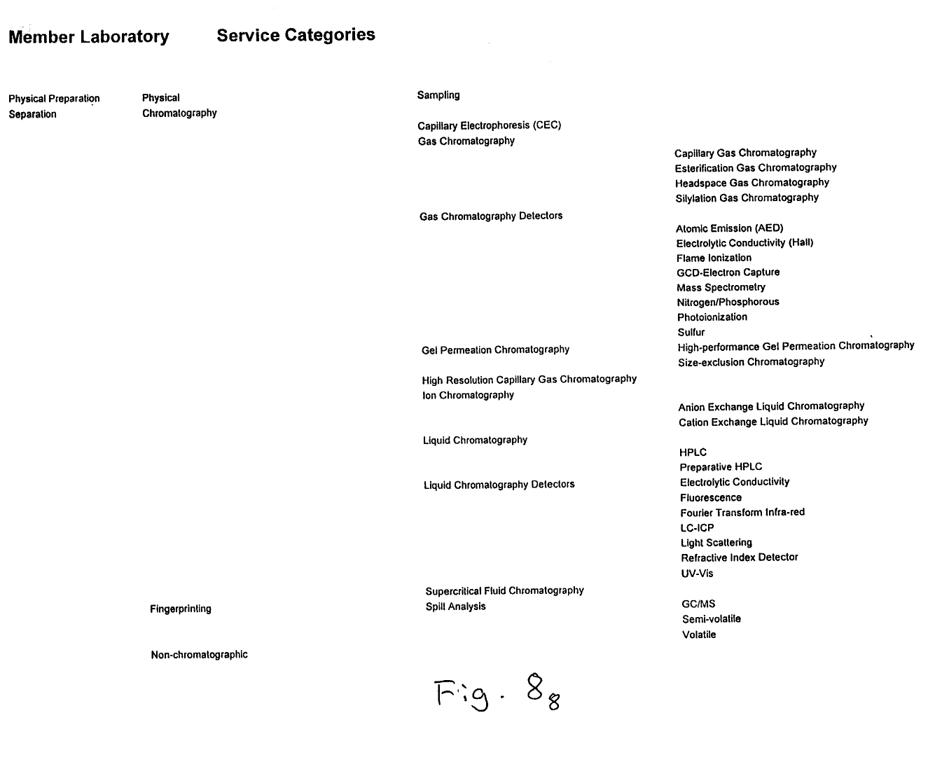

The database will include comprehensive information on the capabilities of each member laboratory. FIG. 7 is an illustration of an example of the front page of a member laboratory capability inventory website tool. FIGS. 8₁-8₁₀ list and organize example categories of the member laboratory capabilities which can be used in the website database. FIGS. 9₁-9₄ list and organize example member laboratory scientist inventory, general information, and capabilities summary which can be used in the website database.

As part of the process of enlisting member laboratories, the brokerage system business can inventory each new member laboratory to determine their capabilities (e.g., instrumentation, scientist resources, test types and specialty capabilities). This inventory can be delivered to the laboratory at no up-front charge as a benefit of membership. Alternatively, depending upon the level of membership, a fee can be charged for this service.

In general, analytical services projects requested by customers, and member laboratory capabilities, can be segregated into three service types and processed accordingly. These service types include:

Research and problem solving.

Standard published methods.

Consulting services.

The member laboratories can also be categorized or classified according to a multi-category, multi-service matrix. These categories can include:

Priority corporate.

Corporate.

Commercial.

Non-profit.

Consulting.

FIG. 10 is a chart describing examples of membership options for member laboratories in the on-line laboratory services brokerage system of the invention.

Typically, priority corporate members will be Fortune 1000-sized corporate laboratories or highly specialized analytical facilities that specialize in problem solving or consulting services. Laboratories of this type may also perform certain standard published method analyses. In one embodiment, priority corporate members pay an annual membership fee only. The membership fee amount can depend upon the size of the laboratory. Pricing to customers include a brokerage system provider project fee. Priority corporate laboratories can also be provided with first priority for responding to RFPs for research and problem solving services and consulting services.

Corporate laboratories will generally have the same qualifications and specialties as priority corporate member laboratories. Corporate members may pay a minimal up-front fee for resource inventory and set-up. The amount of this fee can depend upon the size of the laboratory. Thereafter, the brokerage system business retains a fixed percentage of project revenue. Pricing to customers includes a system business project fee. Corporate laboratories can upgrade to priority corporate category. Corporate laboratories can be granted a second priority for responding to RFPs for research and problem solving services and consulting services.

Member laboratories categorized as commercial will typically specialize in providing standard published methods services. The analyses and pricing that a commercial member laboratory wishes to make available can be visible in catalog format on the website. Commercial member laboratories can be charged a minimal payment for initial resource inventory and setup costs. Thereafter, the brokerage system business can retain a fixed percentage of project revenue. In one embodiment a customer does not pay the operator project fees for standard published methods projects. A commercial laboratory can be provided with a third priority for responding to RFPs for research and problem solving services.

Non-profit member laboratories can be those such as institutes, universities and government agencies. In one embodiment, non-profit member laboratories will pay a minimal up-front resource inventory and setup charge. The brokerage system business will thereafter retain a fixed percentage of project revenue. Customer pricing includes the brokerage system business project fee. Non-profit member laboratories can be assigned fourth priority for responding to RFPs for research and problem solving services and consulting services.

Consulting member laboratories are those that typically work on an hourly basis. In one embodiment, consulting member laboratories will pay a nominal fee for inventory and setup, and a fixed percentage of project revenue to the brokerage system business. Customer pricing will include the brokerage system business project fee. Consulting member laboratories of this type can be provided with the third priority for responding to RFPs for consulting services.

Membership fees can be deferred until revenue is received by the laboratory. The fee can then be deducted as a fraction of revenues to reduce the perceived risk of the cost of membership. Typically, individual consultants will pay relatively small fees to become members. Free memberships can also be used to provide incentives to target laboratories.

### Pricing and Project Fees

A transaction fee can be added to the quoted project price from a member laboratory on each project depending upon the size, scope and complexity of the project. Generally, mark-ups will decrease as project size increases, or as the complexity of the project decreases. This fee can apply to all projects that are defined as research or problem solving. Laboratories not categorized as having priority corporate status can also discount the laboratory's quoted price to the brokerage system business.

### Standard Published Methods Services

Commercial laboratories and research laboratories often perform certain tests using well-known and published methods. This type of testing is often equivalent to a commodity service, and in one embodiment is offered to customers with pricing. Member laboratories may also be offered the opportunity to bid on standard method projects through the website. Furthermore, member laboratories will also have the ability to adjust their own pricing on the database.

In connection with RFPs requesting standard published methods, the customers can also be presented with a list of member laboratories that provide analysis of the method requested (with or without prices). The customer can then choose which laboratory will receive the RFP.

### Automatic Laboratory Selection

The brokerage system website software also has the capability of automatically processing commodity analysis requests in which the customer specifies standard published methods. These requests can be processed automatically without intervention by the operator scientists. This type of service request can be initiated when methods are selected by the use of a drop down list of methods listing specific categories (e.g., EPA, AOAC, ASPN, FDA, etc.). The website application program branches to an automated process in which member laboratories providing the requested service are retrieved and candidate laboratories identified to the customer on-line in real time. The customer can request information about individual laboratories or make their selection of a limited number of member laboratories (or possibly all) member laboratories from which they wish to receive a request for proposal. The RFP is submitted to the website by the customer. The designated member laboratories receive electronic notification of the pending RFPs for the service category. The member laboratories can then access the website to price the requested service or decline to quote.

Customers are notified of the member laboratory's responses, provided the opportunity to review the responses or the status of pending requests without intervention by the project scientist. The customers can also apply software filters which enable them to view only those responses that completely fulfill the RFP requirements. The customer will proceed and make their selection and acceptance of a proposal provided by a member laboratory. Subsequently, the customer will receive shipping notification and the member laboratories notified of the customer selection. Upon completion of the project, the member laboratory will provide the brokerage system business with a report and the customer can retrieve the report from the website. Alternatively, the report can be delivered to the customer by commercial delivery.

A report representing each project derived from a customer's RFP is maintained in an account associated with the customer as an object that can be accessed by either the customer originating the RFP or the member laboratory which performed the project. Each project or RFP is defined by elements stored in a secure database and revisions and the scope of the work are documented as derivatives of the original request. Customers authorize these modifications in the same fashion as the RFP accepted to become a project. Upon completion of the project, the member laboratory may attach electronic reports to the project that may be retrieved upon review and approval by website provider project scientists (including approved creditworthiness and current account payables). Customers can retrieve data and/or electronic project reports from the website over the network, or may review reports at later dates by selecting the project they wish to review from the listed projects attached to their account.

### Research and Problem Solving Services

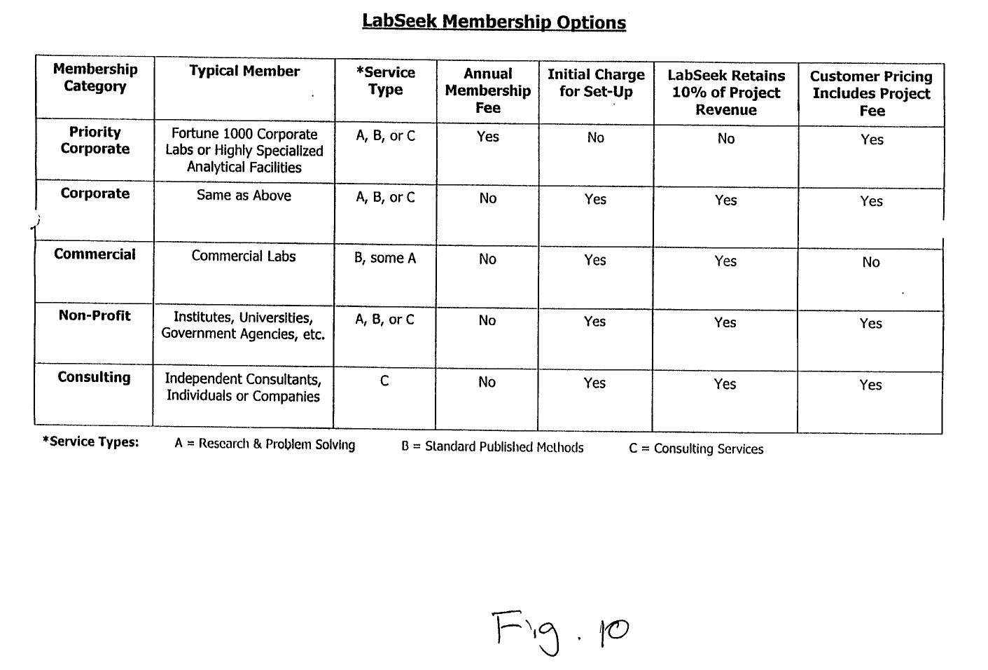

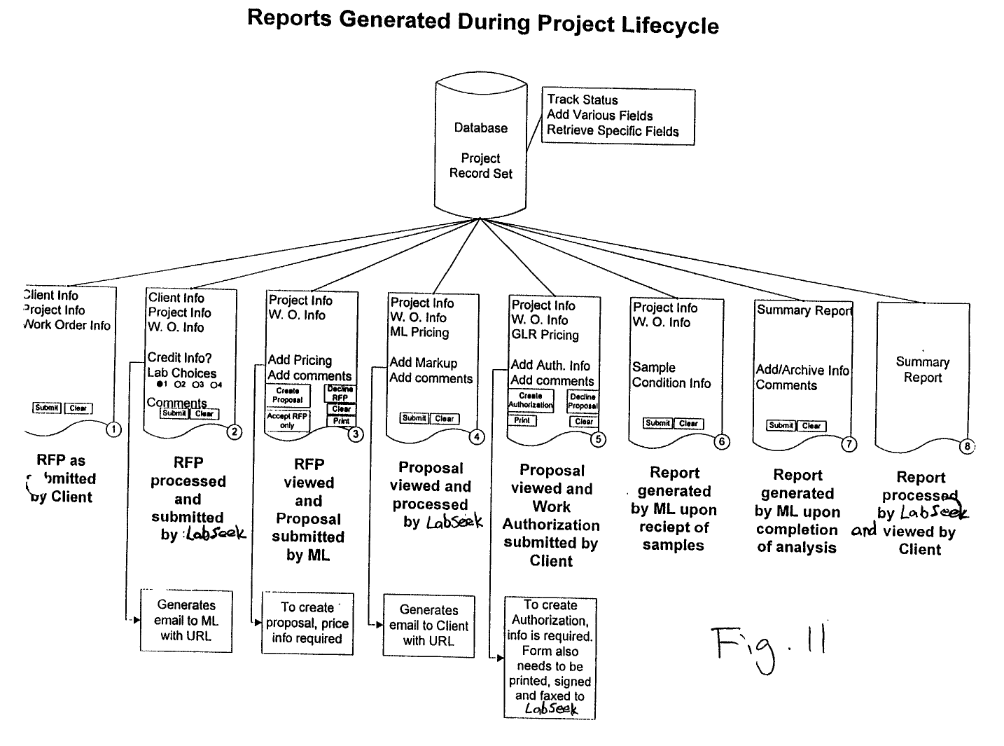

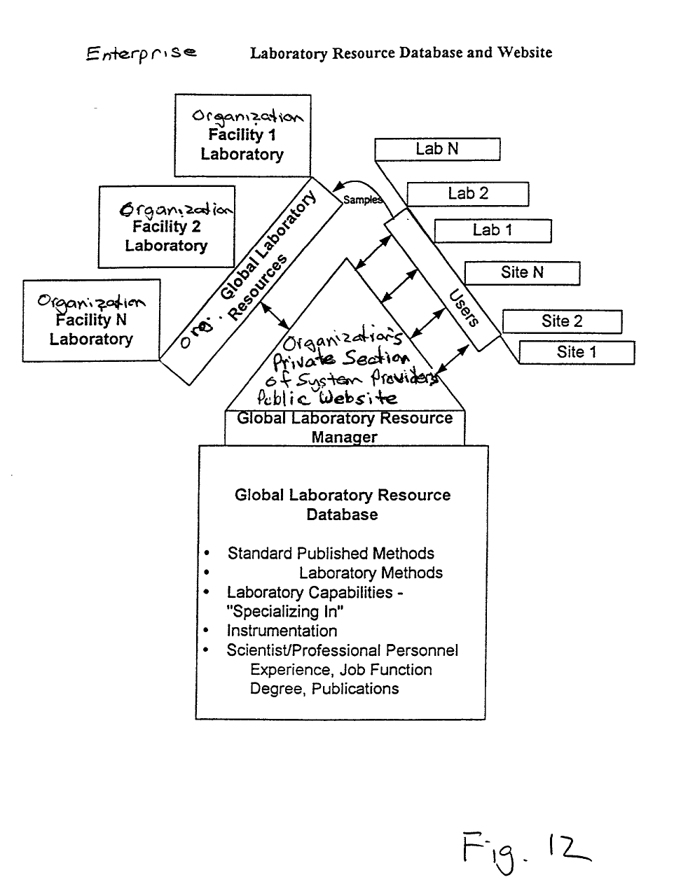

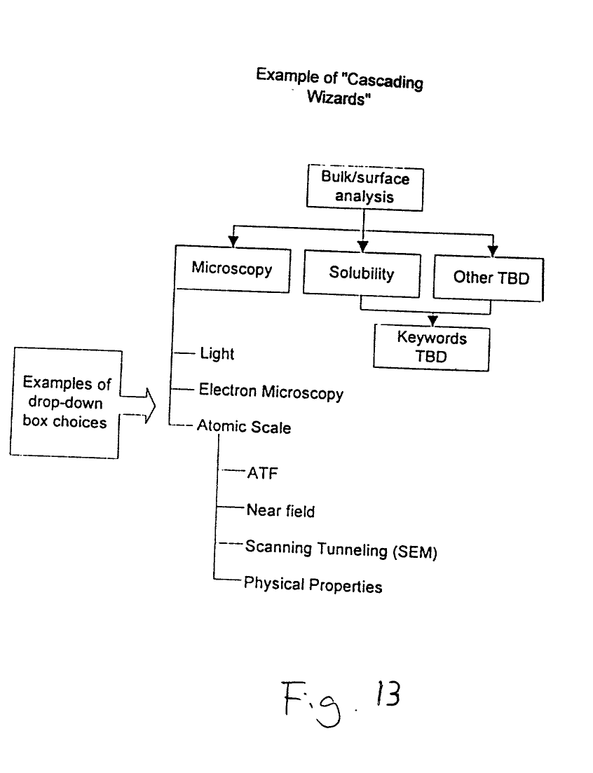

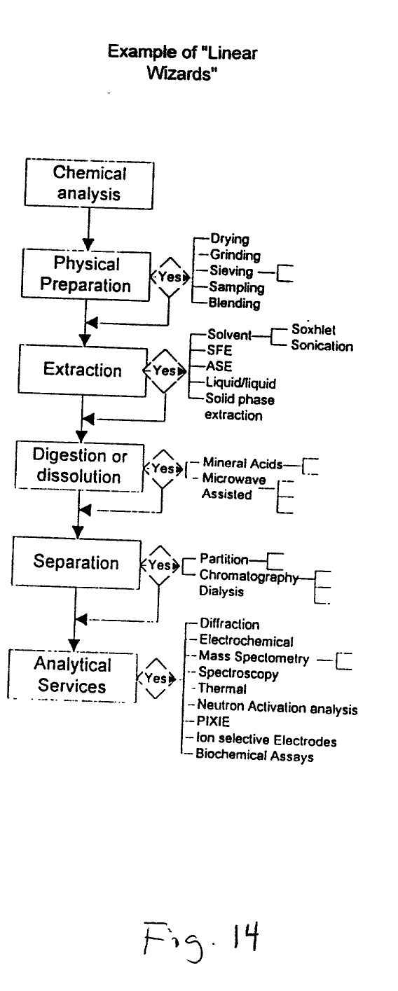

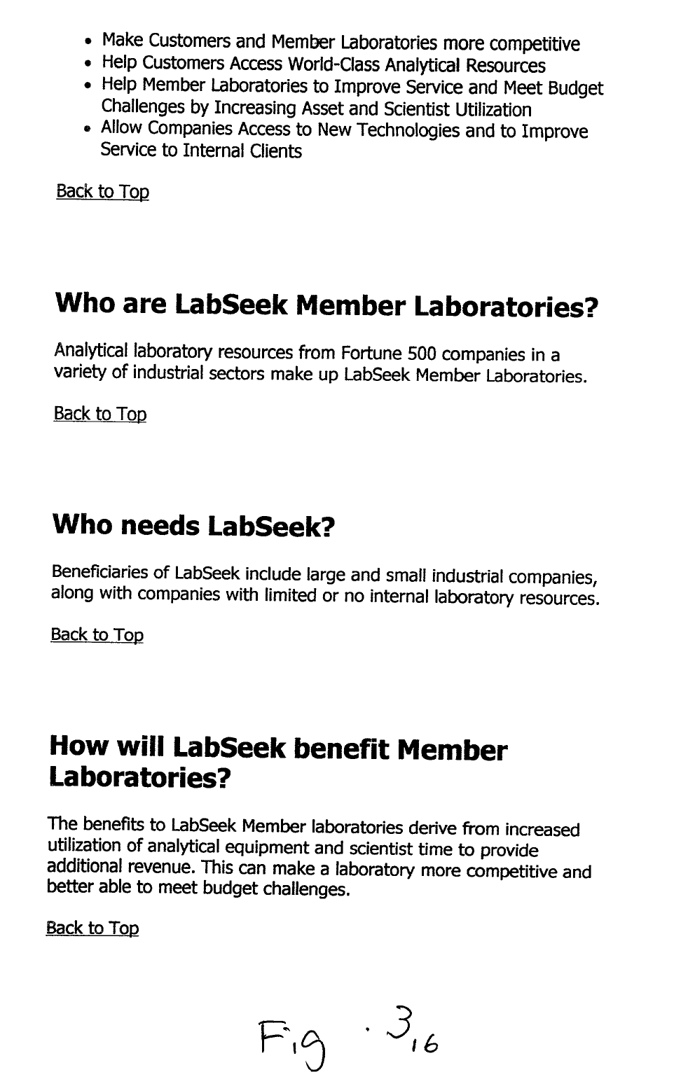

A brokerage system such as that described herein can, in many cases, be the only way for customers to effectively access the sophisticated capabilities of member laboratories who are capable of providing analytical research and problem solving services. Access to these capabilities enables customers to use the brokerage system to conduct research and solve problems through complex projects. FIG. 13 illustrates how a cascading wizard can be used to enable the identification of laboratory capabilities in the database. FIG. 14 illustrates how a linear wizard provides a way for a user to execute multiple cascading wizards to identify laboratory capabilities where complex projects require more than one capability.

### Consulting Services

The brokerage system business can enlist scientific consultants with experience in a variety of testing areas to form a base of knowledge that customers can access to support specific project needs. A consultant knowledge base will enhance the knowledge base inherent in the member laboratories.

### Project Scientist Role

In one embodiment of the invention, the brokerage system business makes use of project scientists or other individuals as intermediaries between customers and member laboratories. The role of the project scientist is to receive the RFPs for services from customers, to perform searches in the database of member laboratories, and oversee ongoing projects. The project scientists may be able to work out of their home.

### Fees

The brokerage system business can derive revenue from membership fees paid by laboratories and at least two types of transaction fees. These fees are project administrative fees and negotiated discounts. Project administrative fees can be charged on projects requiring the brokerage system business to use its expertise to identify the required services and locate an appropriate laboratory to analyze a complex problem. Negotiated discounts will be transaction fees charged in the form of discounts from member laboratory standard prices. Negotiated discounts will be charged on tests that are based on published methods which the system business will competitively bid for customers.

### Samples and Confidentiality

It is generally preferred that customers ship samples directly to a member laboratory that is contracted to provide a laboratory services project involving the samples. However, at additional cost, a customer can request confidential services through the brokerage system provider. Alternatively, the member laboratories can elect to provide only anonymous service. Under these circumstances, the brokerage system provider can receive, repackage and ship samples to assure confidentiality.

One embodiment of the laboratory brokerage system includes three levels of confidentiality to accommodate the needs of member laboratories and customers. A first level has no confidentiality. Both the customer and member laboratory know the identity of the other at this first level. Samples are shipped directly from the customer to the member laboratory.

The second or partial confidential level approach involves the member laboratory not knowing the identity of the customer. However, the customer will know the identity of member laboratory. At this second level, samples are shipped to the brokerage system provider, where they are relabeled (to maintain the confidentiality of the customer) and then sent to the member laboratory.

The third confidentiality level is complete confidentiality. At this level of confidentiality, neither the member laboratory nor the customer will know the identity of the other party. The brokerage system business will be responsible for shipping of samples and data report management to preserve confidentiality.

### Contracts

The business operation of the laboratory services brokerage system is established by execution of contracts between the customer and the system business, and a separate contract between the member laboratory and the system business. Member laboratories agree to be service providers for services that they elect to provide as expressed in the customers' RFPs. Contractual features of the brokerage system business can include:

Responsibility for credit worthiness, billing and collection from customers.

Through its website and secure database, locating and placing customer-defined work with a qualified member laboratory.

Indemnifying member laboratories for business risks except for customer satisfaction arising from data quality issues.

Providing payments to member laboratories for services provided per customer requests.

Providing and supporting the website and secure database with proprietary member laboratory data that is not made public.

Members can decline to “reverse engineer” a patented or proprietary product if the RFP does not disclose the same.

Contractual obligations of the member laboratories can include:

Agreeing to provide responses to RFPs in a certain period of time, and acknowledging receipt and notification of pending RFPs.

Agreeing not to service customers placed with member laboratories except through the brokerage system business.

Agreeing to maintain security and confidentiality of customer information.

Agreeing to allow the brokerage service operator to identify member laboratories as a system provider on the website.

Agreeing to provide resource information for use in the system database.

Agreeing not to be obligated to accept RFPs provided to member laboratories.

Contractual obligations of the customer can include:

Agreeing to business terms of the customer contract maintained on the website.

Executing a contract prior to receiving responses to RFPs.

Agreeing not to contact member laboratories directly.

### Laboratory Capability Inventory Tool

Member laboratories' capabilities can be efficiently captured and transferred to the brokerage system database through the use of a software tool. One embodiment of the tool is configured for use with personal computers using Microsoft Access software. The software tool mirrors the structure on the website database, which in the above embodiment is supported by a Microsoft SQL server. The software tool provides the ability to input by keyboard, external spreadsheet or flat ASCII files, the full description of a member laboratory's capabilities that the laboratory elects to make available. The capabilities which can be input include those illustrated in FIGS. 8₁-8₁₀ and 9₁-9₄. FIG. 7 is an illustration of an example of the front page of a member laboratory capability inventory website tool which can be used by customers to enter the information for subsequent transfer as described above.

### Enterprise Version of Brokerage System

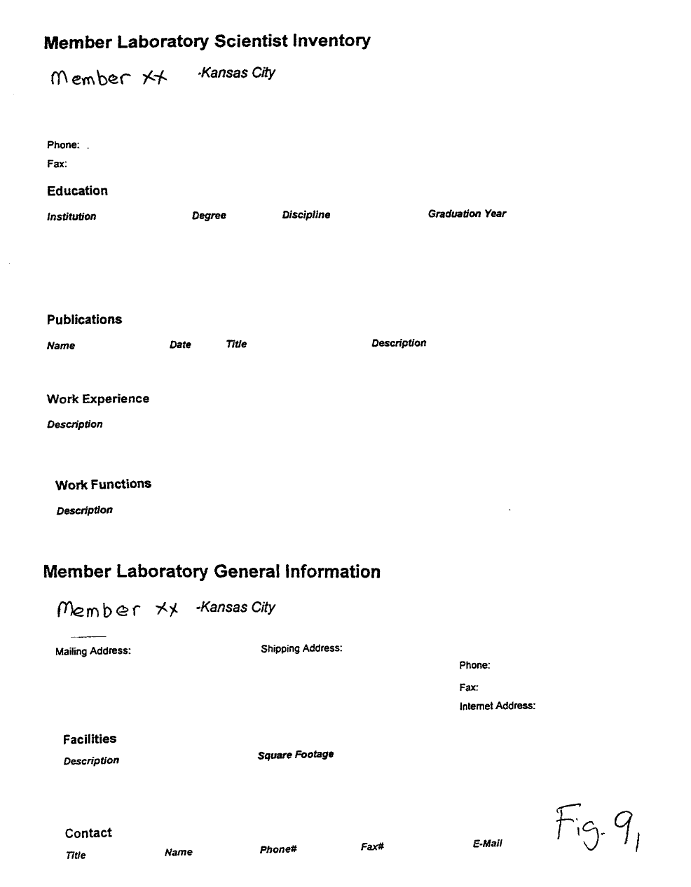

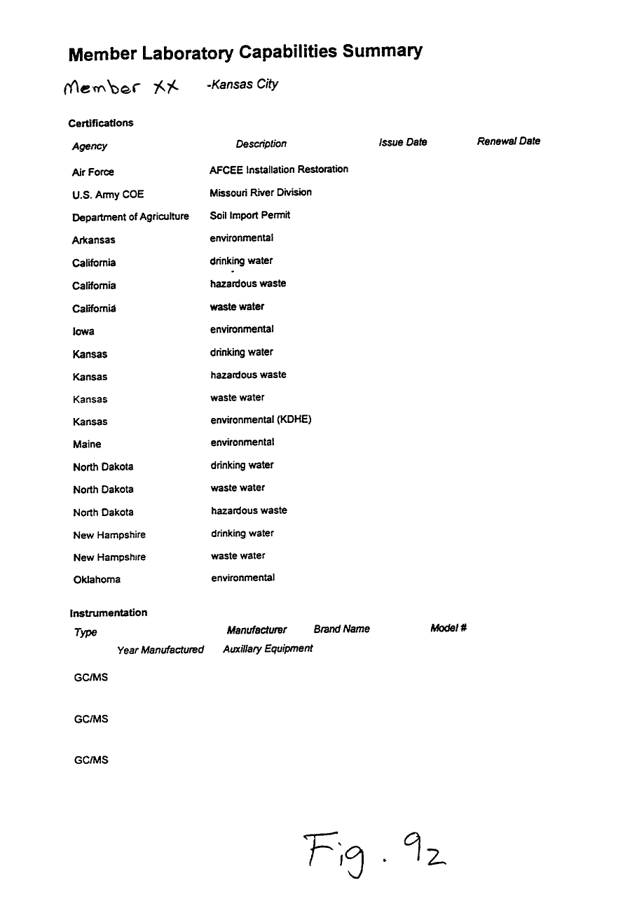

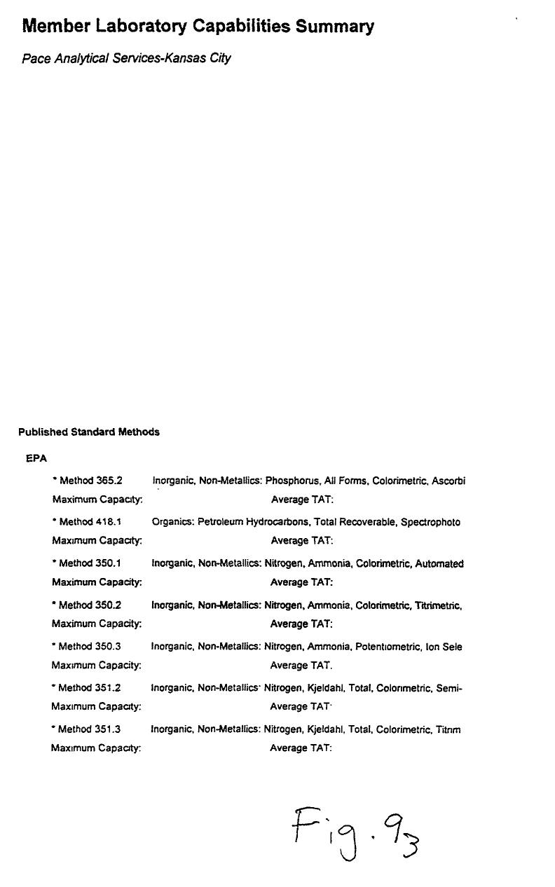

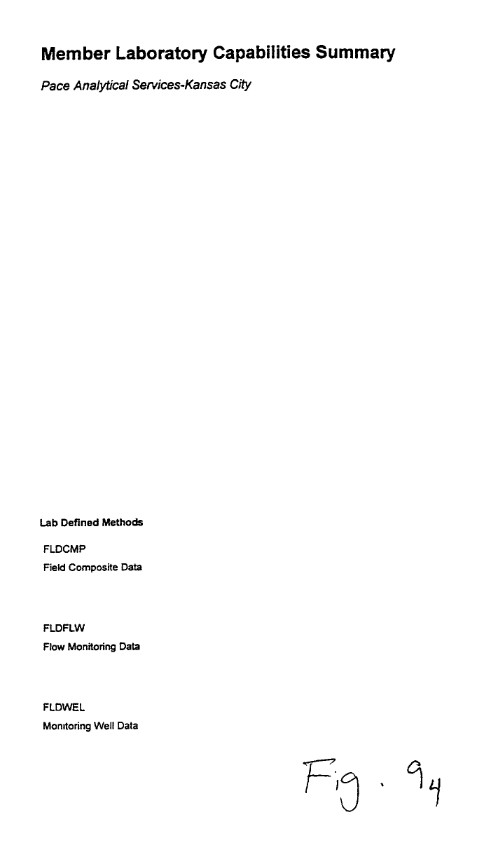

An alternative embodiment the invention is configured as an internal or enterprise version. In this embodiment, an organization having dispersed laboratory resources (e.g., multiple sites or multiple laboratories at a single site) can host the enterprise version of the website under its IT responsibility. FIG. 12 is a graphic illustration of a database and website for an enterprise version of an on-line laboratory services brokerage system. A server version of the brokerage system software having capabilities similar to those described above can be prepared for operation at the designated site (e.g., over the organization intranet). The database and website software can be transferred to the operator of the organization's system, and installed on the appropriate hardware. Arrangements can be made for the necessary training for personnel at the organization to perform the resource matching functions. Software tools and databases of the type described above can be used to identify and inventory the laboratory capabilities. These capabilities can then be entered into the database, and searched to identify internal capabilities available to meet internal project needs.

The enterprise brokerage system can be operated in one of several scenarios. In one approach, the enterprise software would be hosted on the brokerage service provider site (e.g., the LabSeek or GLR site) as a secure segment of the system provider site. This approach would entail:

Creation of a dedicated database for the customer resource inventory for each analytical support site. Customer scientists would be primarily responsible for and assist in developing analytical data for inventory.

Development of a password-secured website tailored to the customer's requirements.

Maintenance of hardware and software.

License of the software for dedicated use.

In this approach, the application would operate on the brokerage provider's server, eliminating the need for additional hardware and internet connectivity expenses.

Another alternative is the development of a tailored internet or intranet website for operation by the customer group laboratory. The capabilities inventory and application can be located on a website developed either for the internet or for the laboratory's intranet, depending upon the operating scenario for use by the laboratory's employees. The website can use the design of the system business described above to coordinate interactive requests and responses to laboratory testing needs. The site of an application can be installed either on the company's existing web service or on dedicated hardware. prepared by the laboratory service provider.

Under either scenario, the website can be monitored by the staff of either the brokerage system business or the customer. If the brokerage system business hosts the enterprise site, a staff person can be assigned responsibility for administering the resource matching operation.

An important step in managing a resource is to understand the resource. The enterprise version of the system would create an acute knowledge of available internal analytical resources. The ready availability of detailed methodology and professional experience profiles can lead to increased utilization of those resources. The enterprise version would allow individual laboratory operations to eliminate or consolidate underutilized assets and human resource costs, reducing the budget while continuing to meet the needs of internal customers. The brokerage system business would be alert to capabilities which are used infrequently, and can make recommendations on the consolidation of needs of specific laboratories. Also, infrequent tasks could be routed to and performed in a central analytical laboratory, reducing the overall operating costs of the laboratory that had been performing the work.

The results of the inventory process and database creation would be a functional website with one database manager that would be responsible for system operation. The manager would:

Search the database to match needs with services and forward requests to the most qualified laboratory.

Receive information on cost and availability of services.

Originate searches for resources involving scientific experience and instrumentation.

Coordinate sample transfer and communications.

The brokerage system business can collect available information describing the customer or subscriber laboratory's scientific capabilities and categories. Following the collection and review of information from each laboratory, summary reports can be prepared. The brokerage system scientists can then utilize the brokerage system's website inventory tool and work with technical and/or laboratory managers at the subscriber to locate and capture existing capabilities information and to identify contact points at selected facilities. Resource information can be entered into the database manually or electronically from existing ASCII files for spreadsheets. Subsequently, after validation by the facility manager, the data for each facility can be appended to the enterprise website. The inventory process can collect all information of the type described above in connection with the brokerage system website, or selected subsets of the information.

### Consortium Version

The network-based brokerage system of the type described above can also be used by an organized group of laboratories from different companies (e.g., DIRAG) to exchange laboratory services. It is expected that the value of exchanging services between companies in this manner can be significant. Benefits would include:

Using other members laboratories for overflow work.

Offering excess capacity to other members to improve financial performance.

Accessing other members' technology and expertise to improve service to internal customers.

These benefits can be achieved by the consortium members without disrupting the current structure of the laboratory or any organization between the members. The opportunity is presented without commitments or risks.

The system can be implemented using the website and software of the brokerage system business described above. A secure logon for the consortium members would direct them to the custom consortium site. Laboratories choosing to participate would work with the brokerage system business to create an inventory of capabilities which would be entered into the consortium member capability database. Details of the inventory would be accessible only by the brokerage system business scientists. This detailed inventory of capabilities would be secure and not accessible by other members of the consortium.

Members of the consortium that choose to participate in the consortium version of the brokerage system will negotiate contracts with the brokerage system business to facilitate the transfer of work between members through the operator website. The contracts can address issues related to being a provider of services and a customer of services.

Consortium members in need of analytical support or who are seeking expertise in a certain area would log on to the brokerage system business website and move to the secure consortium section to create a request for proposal. Project scientists of the brokerage system business would then complete a search in the database for the best consortium member laboratory to meet the needs identified in the RFP, and send the RFP to the identified laboratory. If the laboratory is unable to accept the project, the brokerage system business would find the second best qualified consortium member laboratory. Consortium members would also be able to specify the consortium member laboratory that they would like to use for their work. If no consortium member laboratory is available to perform the services, the brokerage system business could expand the search to the entire brokerage system business database. The consortium member would then determine whether they wish to utilize the capabilities that are identified.

The brokerage system provider can also establish barter accounts for the consortium members. The barter account can be used to allow for banking of credit for services performed. Credit accumulated from performing services for other consortium members could then be used to purchase services from other members, thereby eliminating the need to manage cash received for services performed. The brokerage system business can administer the mechanisms for consortium member laboratories to purchase goods or services from other member laboratories using the credit established in their account. This barter system would provide a mechanism for laboratories to improve their financial performance against budget and serving internal customers without the normal administrative issues of outsourcing or insourcing work.

In one embodiment of the consortium version, the cost of participation will be limited to the cost of performing the inventory of each consortium member laboratory, and the cost of updating that inventory on a periodic (e.g., annual) basis. Alternatively, the brokerage system business can absorb the initial cost of the inventory and recover that cost through fees associated with the exchange of services between the consortium member laboratories. Transaction fees can be added to the proposals offered to consortium members by the brokerage system business. These fees can be paid by the customer consortium member. The amount of the fee can vary depending upon the size and the complexity of the project and the amount of involvement of the brokerage system business personnel.

### Wizards

FIG. 13 is a graphic example and flowchart of a cascading wizard which can be used in connection with the brokerage systems described above. Through the wizard, the system provides a structured process whereby a user can specify or select information about a capability, such as where the capability resides in a hierarchical classification of capabilities. Based on the specified or selected information, an end point of one capability can be identified in the database of capabilities that have been inventoried for each laboratory.

FIG. 14 is a graphic example and flowchart of a linear wizard which can be used in connection with the brokerage systems. The linear wizard is composed of multiple cascading wizards stacked on top of one another. The steps can be interdependent steps, which will allow the results of one step to narrow the focus of the subsequent steps in the stack.

These wizards are particularly useful in connection with research and problem solving projects, where laboratories' capabilities must be identified and selected, and where typically more than one capability is required to complete a project.

### Barter Accounts

Similar to the barter accounts described above in connection with the consortium version of the system, the system business can establish barter accounts which will enable all member laboratories to receive credit for services performed instead of receiving cash payments. This approach will allow member laboratories that are providing services to customers under the system to avoid administrative issues associated with receiving cash payments from the system business. Credit in the barter accounts can be used by the member laboratories to purchase laboratory services from other member laboratories or to purchase laboratory equipment. The brokerage system business can purchase new or used equipment for the member laboratories with credit from the barter accounts, and then transfer title to the member laboratory. In one embodiment, the member laboratory could request that the account be “cashed in” at any time.

### Chat Structure

The brokerage system business can also establish a chat and content structure (known as a “plaid” chart) on the website. This matrix of vertical communities and technical communities will allow scientists that specialize in certain technical areas to communicate with scientists in the same technical areas, but in different industries. This structure can draw scientists to the brokerage system provider site as a place to interact with their peer community, and do business.

### Conclusion

The on-line brokerage system of the present invention offers a number of important advantages. The system provides a marketplace for laboratory services for connecting a broad range of customers seeking services with a comprehensive network of member laboratories. Laboratory services include all types of environmental, pharmaceutical, agricultural, and chemical testing, as well as routine testing and research and problem solving in other industries requiring scientific measurement and analysis. The business simplifies and streamlines the otherwise inefficient process of identifying laboratories with the required capabilities, locating the most qualified laboratory and negotiating the terms of the transaction. The web-based process quickly and efficiently accesses the member laboratory network, utilizing industry expertise to facilitate identification of the ideal laboratory and achieve optimal pricing. Customers can make use of the business for competitive bidding of published methods and tests or use the system provider's industry expertise and network of member laboratories to solve unique problems. Member laboratories benefit by utilizing their excess capacity. This excess capacity is large in general, as the work flow of individual laboratories is highly unpredictable, while fixed costs are high due to the equipment and highly-trained staff that must be retained regardless of the level of use. Customers can also purchase services that are outside their own laboratory's capabilities. The bartering system will allow member laboratories to exchange these services, thus reducing the need for cash expenditures.

One embodiment of the invention is an on-line method for brokering laboratory or other service projects, including: 1) maintaining a database of participating (e.g., member) laboratory capabilities; 2) receiving electronically, over a network (e.g., the internet and/or an organization-wide intranet), customer requests for proposals (RFPs) for laboratory service projects; 3) selecting from the database one or more participating laboratories which may be capable of performing the requested laboratory service projects; 4) providing electronically to the selected participating laboratory(s), over the network, descriptions of the requested projects and the opportunity to make proposals of the terms on which it desires to pursue the project (e.g. to accept, reject or negotiate changes to the project); 5) receiving electronically, over the network, the proposals from the selected participating laboratory(s) with the terms on which it desires to pursue the projects; and 6) providing electronically to the customers, over the network, the proposals from the selected member laboratories with the opportunity to make decisions on the proposals. Any embodiment of the invention can also include any or all of the following features.

The step of receiving RFPs for laboratory service projects can include receiving RFPs for published standard methods. Selecting participating laboratories from the database can include electronically, without human intervention, searching the database and selecting one or more participating laboratories capable of performing the requested published standard methods. Receiving RFPs for laboratory service projects can include receiving RFPs for customer defined methods. Selecting participating laboratories from the database can include having a scientist search the database and select one or more participating laboratories capable of performing the requested service projects.

The step of receiving RFPs for laboratory service projects can include receiving RFPs for projects having a plurality of method/service components. The method can further include: 1) having a scientist divide the projects into a plurality of method/service components; and 2) selecting participating laboratories from the database can include searching the database and selecting one or more participating laboratories capable of performing each method/service component. Providing descriptions of the requested projects to the participating laboratories can include providing descriptions of the requested projects in a standardized format. Providing the descriptions of the requested projects includes having a scientist prepare the descriptions of the requested projects in a standardized format. Receiving RFPs for laboratory service projects includes receiving RFPs for projects involving consulting services and/or client-defined needs. Maintaining a database of participating laboratories can include maintaining a database of information including laboratory instrumentation, test methods, scientist qualifications, laboratory credentials, laboratory service categories, scientist inventory and/or capabilities summary.

Providing descriptions of requested projects can include: 1) posting the descriptions of the requested projects at a location on the network accessible by the participating laboratories (e.g., at an internet site); and 2) sending notices to the selected participating laboratories that descriptions of requested projects are posted. Receiving the proposals from the selected member laboratory(s) includes receiving information representative of the member laboratory(s) acceptance the requested project, rejection of the requested project or proposal to modify the requested project. Providing the customers with the opportunity to make decisions on the proposals includes providing the customers the opportunity to accept, reject or negotiate changes to the proposals.

The method can further include receiving, over the network, the customers' decisions on the proposals. An on-site inventory of at least some of the participating laboratories' capabilities can be conducted. The method can also include categorizing the participating laboratories and providing the descriptions of the requested projects to the participating laboratories at priorities related to the associated categorizations. At least some of the participating laboratories can pay a fee to be a participating laboratory. At least some of the participating laboratories pay no fee to be a participating laboratory.

Some of the participating laboratories can pay a fee to be a participating laboratory, some of the participating laboratories can pay no fee to be a participating laboratory, and participating laboratories that pay a fee are provided benefits not provided to participating laboratories that pay no fee. The benefits provided to participating laboratories that pay a fee can include priority of opportunities to make proposals of the terms on which it desires to pursue the projects. Benefits provided to participating laboratories that pay a fee can include favorable project fee pricing.

Member laboratories can be charged fees when the laboratories accept requested projects. Charging a fee can include charging a commission on the project charge offered by the member laboratory. Charging a fee can also include adding a fee to the project charge offered by the member laboratory.

The method can also include maintaining a searchable database record of customer RFPs and/or a searchable database record of member laboratory proposals. Contracts can be entered into with the customers and/or participating laboratories. Barter accounts enabling participating laboratories to register credit for accepting requested projects can be established. Access can be provided to a database of scientists indexed by technical expertise and/or industry. Access can be provided to a network chat room enabling technical communications with scientists identified in the database of scientists.

The brokerage system business can operate a web site to perform the method. The method can be implemented by a programmed server.

One or more reports describing the results of the project can be received electronically from the participating laboratory that performed the laboratory service project, over the network. One or more reports describing the results of the project can be provided electronically to the customer, over the network. The method can include maintaining searchable database reports describing the results of projects performed for customers. Access to the database of the results of projects performed for the customers can be provided electronically to the customers over the network.

The participating laboratories can be provided with the ability to prevent their identity from being communicated to the customers (i.e., the participating laboratories can remain anonymous to the customers). Entering into contracts can include entering into contracts with the customers and the participating laboratories so the projects can be performed without the requirement of a contract between the customers and the participating laboratories.

The method can include taking payments from the customers for projects performed for the customers, and providing payments to the member laboratories for projects performed by the member laboratories (i.e., the on-line broker pays the member laboratories and assumes the risk that the customers will pay for projects performed, so there is no requirement that payments be made directly from the customers to the member laboratories).

The customers can send samples associated with projects to be performed directly to the participating laboratories performing the projects. The method can also include receiving from customers samples associated with projects to be performed by the participating laboratories, and sending to the participating laboratories the samples associated with the projects to be performed. Samples received from the customers can be coded before sending them to the participating laboratories to maintain customer confidentiality. Receiving customer RFPs can include receiving a short form RFP which is a subset of information on a full RFP form.

What is claimed is:

1. An on-line method for brokering scientific laboratory services, including:
enlisting and maintaining a network of member laboratories having underutilized scientific laboratory capabilities;
maintaining an electronic database of the member laboratory capabilities;
receiving electronically, over a network, customer requests for proposals (RFPs) for laboratory service projects;
selecting from the database one or more member laboratories which may be capable of performing the requested laboratory service projects in the RFPs;
providing electronically to the selected laboratories, over the network, descriptions of the requested laboratory service projects, and presenting the selected laboratories the opportunity to make proposals of the terms on which the laboratories desire to pursue the requested laboratory service projects;
receiving electronically, over the network, the proposals from the selected laboratories with the terms on which the laboratories desire to pursue the requested laboratory service projects; and
providing electronically to the customers, over the network, the proposals received from the selected member laboratories, and presenting the customers the opportunity to make decisions on the proposals.

2. The method of claim 1 wherein receiving RFPs includes receiving RFPs for published standard methods.

3. The method of claim 2 wherein:
the method further includes providing electronically to the customers, over the network, descriptions of published standard methods in a predetermined format;
maintaining a database of member laboratory capabilities includes maintaining descriptions, in the predetermined format, of member laboratory capabilities to perform the published standard methods;
receiving RFPs for standard published methods includes requesting the customers to submit RFPs for standard published methods using the predetermined format; and
selecting member laboratories from the database includes electronically, without human intervention, searching the database and selecting the member laboratories that may be capable of performing standard published methods requested in RFPs using the predetermined format.

4. The method of claim 3 wherein:
receiving RFPs includes receiving RFPs for customer defined methods; and
selecting member laboratories from the database includes having a scientist review the RFPs for customer defined methods, search the database and select the member laboratories that may be capable of performing the customer defined methods.

5. The method of claim 4 wherein providing descriptions of requested customer defined methods to the selected laboratories includes having a scientist prepare the descriptions of the requested customer defined methods in a standardized format.

6. The method of claim 2 wherein receiving RFPs also includes receiving RFPs for customer defined methods.

7. The method of claim 1 wherein receiving RFPs includes receiving RFPs for customer defined methods.

8. The method of claim 7 wherein selecting member laboratories from the database includes having a scientist review the RFPs for customer defined methods, search the database and select the member laboratories that may be capable of performing the customer defined methods.

9. The method of claim 1 wherein:
receiving RFPs includes receiving RFPs for projects having a plurality of method/service components;
the method further includes having a scientist divide the projects into a plurality of method/service components; and
selecting member laboratories from the database includes searching the database and selecting member laboratories having a capability enabling the laboratories to perform each method/service component.

10. The method of claim 1 wherein providing descriptions of the requested projects to the selected laboratories includes providing descriptions of the requested projects in a standardized format.

11. The method of claim 10 wherein providing the descriptions of the requested projects includes having a scientist prepare the descriptions of the requested projects.

12. The method of claim 1 wherein maintaining a database of member laboratories includes maintaining a database of information about each laboratory including one or more laboratory capabilities including laboratory instrumentation, test methods, scientist qualifications, laboratory credentials, laboratory service categories, scientist inventory and capabilities summary.

13. The method of claim 1 wherein enlisting and maintaining a network of laboratories includes conducting an on-site inventory of at least some of the participating laboratories capabilities.

14. The method of claim 1 wherein:
the method further includes categorizing the member laboratories; and
providing descriptions of the requested laboratory projects includes providing descriptions of the requested laboratory projects to the member laboratories at priorities related to the laboratories' categorization.

15. The method of claim 14 wherein categorizing the member laboratories includes categorizing the member laboratories on the basis of one or more factors from the set including service type, membership fee amount, initial charge for set-up and revenue charges for performing projects.

16. The method of claim 14 wherein:
some of the member laboratories pay a first fee to be a member laboratory;
some of the member laboratories pay a second fee which is less than the first fee to be a member laboratory; and
member laboratories that pay the first fee are provided benefits which are not provided to member laboratories that pay the second fee.

17. The method of claim 16 wherein the benefits provided to member laboratories that pay the first fee include priority of opportunities to make proposals of the terms on which the laboratories desire to pursue the projects.

18. The method of claim 1 and further including charging fees for the performance of requested projects by member laboratories.

19. The method of claim 1 and further including entering into written contracts with member laboratories before providing the member laboratories with the opportunity to make proposals of the terms on which the laboratories desire to pursue the projects.

20. The method of claim 19 and further entering into written contracts with the customers before selecting member laboratories that may be capable of performing the service projects requested by the customers.

21. The method of claim 20 and not requiring a written contract between member laboratories and customers.

22. Operating a web site to perform the method of claim 1.

23. An information system programmed to implement the method of claim 1.

24. The method of claim 1 and further including receiving electronically from the member laboratories, over the network, reports describing the results of projects performed by the laboratories.

25. The method of claim 24 and further including providing electronically to the customers, over the network, the reports from the member laboratories describing the results of the projects performed by the laboratories.

26. The method of claim 1 wherein the customers send samples associated with projects to be performed directly to the member laboratories performing the projects.

27. The method of claim 1 and further including:
receiving from customers samples associated with projects to be performed by the member laboratories; and
sending to the member laboratories the samples associated with projects to be performed for customers.

28. The method of claim 27 and further including maintaining the identity of the customers associated with the samples confidential from the member laboratories to which the samples are sent.

29. The method of claim 1 wherein selecting member laboratories from the database includes electronically, without human intervention, searching the database and selecting the member laboratories that may be capable of providing capabilities to execute the projects requested in the RFPs.

30. The method of claim 29 and further including providing a wizard for enabling the identification of laboratory capabilities.

31. The method of claim 30 wherein providing a wizard includes providing a cascading wizard enabling the identification of a laboratory's capability by guiding a user through a classification hierarchy.

32. The method of claim 30 wherein providing a wizard includes providing a linear wizard that executes multiple cascading wizards.

33. The method of claim 30 wherein maintaining a database of member laboratory capabilities includes maintaining a database of member laboratory capabilities in a format corresponding to the logic of the wizard.

34. The method of claim 1 and further including providing a tool for enabling the member laboratories to input information describing their laboratory capabilities.

35. The method of claim 34 wherein providing a tool includes providing an on-line tool for enabling the member laboratories to input information describing their laboratory capabilities.

36. The method of claim 1 wherein receiving RFPs includes receiving RFPs for complex research projects.

37. The method of claim 24 and further including maintaining an archive of the results of projects performed by the laboratories.

38. The method of claim 1 and further including providing electronically to the selected laboratories, over the network, notices that descriptions of the requested laboratory service projects are available for review.

39. A method of claim 1 and further including providing electronically to the customers, over the network, notices that descriptions of proposals and project status information are available for review.
